(19) United States
(12) Patent Application Publication
(10) Pub. No.: US 2026/0336934 A1
(43) Pub. Date: Oct. 29, 2026

(54) SYSTEMS AND METHODS FOR CONTROLLING A HIGH-DENSITY AUTOMATED STORAGE AND RETRIEVAL SYSTEM HAVING PSEUDO-CONTINUOUS MOTION

(71) Applicant: CARNEGIE MELLON UNIVERSITY, Pittsburgh, PA (US)

(72) Inventors: HERMAN HERMAN, Pittsburgh, PA (US); GABRIEL GOLDMAN, Pittsburgh, PA (US); NISHANT POL, Pittsburgh, PA (US); RYAN SARVER, Pittsburgh, PA (US)

(73) Assignee: CARNEGIE MELLON UNIVERSITY, Pittsburgh, PA (US)

(21) Appl. No.: 19/108,655

(22) PCT Filed: Nov. 16, 2023
(86) PCT No.: PCT/US23/80082

§ 371 Date: Mar. 4, 2025

Related U.S. Application Data
(60) Provisional application No. 63/427,269, filed on Nov. 22, 2022.

(51) Int. Cl. B65G 1/137; B65G 1/06; G06Q 10/087

(52) U.S. Cl. CPC B65G 1/1371; B65G 1/065; G06Q 10/08741; B65G 2203/0216; B65G 2203/0233

(57) ABSTRACT

Disclosed herein is a system and method for controlling a high-density storage system comprising a plurality of layers, each layer comprising a plurality of rows for storing a plurality of coupled totes and one or more carriers located on opposite ends of each layer, each carrier being multiple rows wide, each carrier capable of retrieving totes from a row in the layer, depositing a tote into a row in the layer and shifting totes from one row to another within the layer.

### RELATED APPLICATIONS

This application is a national filing under 35 U.S.C. § 371 claiming the benefit and priority to International Patent Application No. PCT/US23/80082, filed Nov. 16, 2023 entitled “SYSTEMS AND METHODS FOR CONTROLLING A HIGH-DENSITY AUTOMATED STORAGE AND RETRIEVAL SYSTEM HAVING PSEUDO-CONTINUOUS MOTION”, which claims the benefit of U.S. Provisional Patent Application No. 63/427,269, filed Nov. 22, 2022, the contents of which are incorporated herein their entireties.

### BACKGROUND

Companies are pushing to maximize the storage density and efficiency of automated storage and retrieval systems (AS/RS) in their order fulfillment process. AS/RS systems use automated carriers that typically move either between or on top of structures that hold products or totes filled with products. In the case of systems where carriers move in between aisles of products and/or totes, there is a limit as to how dense the system can be in that the space required for the carrier movement reduces the overall potential storage density of the system.

Some systems maximize density by stacking products or totes vertically, which maximizes storage density, but has potentially lower efficiency when retrieving products or totes that are buried lower in the stacks. In one case, a gantry services a range of totes that are stacked on the floor, which minimizes infrastructure but ultimately has a limit on performance based on a limited number of gantry arms overlapping the same workspace. In another case, the system stacks totes vertically within a raised structure. Retrieval robots lift the totes from the top one-by-one. This results in a limit on performance to retrieve totes that are lower in the stack with each lift taking a longer amount of time proportional to the height of the tote stack or product being lifted.

### SUMMARY OF THE INVENTION

The embodiments described herein provide the capability for a highly dense storage solution while also providing a high level of performance, thereby improving both density and speed of retrieval over prior art systems. Instead of stacking the totes vertically (which has an inherent height limit due to the mechanical limit and the weight of the totes), the totes are arranged in horizontal layers of rows within a passive supporting structure. Unlike other systems, the totes are mechanically coupled to allow for a row of horizontally connected totes to be pulled and/or pushed together as a unit by pulling or pushing one or more totes on the end of a row, which will also pull or push all other totes within that same row that are connected to each other. This arrangement allows any totes within a row to be retrieved by repeatedly pulling and decoupling the outer tote or totes from the row until the right tote is retrieved. It also allows for the easy storage of totes. A tote could be stored in this AS/RS system simply by pushing a tote into a row that has an empty spot. As that tote is pushed into that row, it will automatically couple itself longitudinally when it comes into contact with the totes that are already in that row. This efficient storage approach could also be used to store totes that were removed from a row to access a tote-of-interest initially located on the interior of a row for retrieval.

The described embodiments store totes within a layered support structure. This structure supports the weight of all totes as well as providing rows within the structure in which totes can be stored. The totes are placed into the structure rows through a horizontal motion in a similar manner to other rack-based storage solutions. The novel storage structure allows for a high number of totes to be stored in a single row, whereas more standard rack structures allow for only a small number of totes or packages to be stored on a given shelf, because there is no efficient way to access totes that are located deep in the row. The described embodiments are able to retrieve totes from anywhere within a row upon request with a high level of performance in comparison to other high-density storage solutions. This is possible since all totes, no matter how deep they are located in the row, could be accessed just by pulling on the outside totes until the tote-of-interest is at the edge of the row. Pulling on the outer tote or totes will also pull all the other totes that are coupled, thereto allowing the tote-of-interest to be pulled toward the end of the row for retrieval.

In one embodiment, disclosed herein is a piecewise retrieval sequence for connected totes within a storage structure as well as the continuous retrieval sequence for connected totes that features motion of connected totes into or out of a row at a constant velocity. Once a tote is moved onto a carrier, it is shifted to a target row in a piecewise, non-continuous, manner in a direction orthogonal to the source row. Once the tote is aligned with the target row, it is accelerated into the row and couples with totes already in the row and thereafter moves at the same constant velocity as the totes in the row. Systems and methods for controlling the retrieval and storage sequence are described.

The disclosed invention comprises three different types of drives for moving the totes. A continuous drive mechanism is responsible for moving the totes into and out of the rows at a constant velocity. An acceleration drive mechanism is responsible for accelerating a tote from the carrier into a row such that it “catches up” to the tote at the end of the row and couples with it, as the row is moving away at a constant velocity. The third type of drive is a side shift drive mechanism that is responsible for shifting the totes on the carrier from a source row to a destination row. Systems and methods for controlling the various drives are described.

In other aspects of the invention, different features for improving the efficiency of the storage structure are disclosed. These include, for example, various configurations of the three different types of drives, a cantilevered area in the storage structure which allows the continuous drive to be positioned between the layers, improvements to the storage structure to optimize the intake of totes into the system and the output of totes from the system and improvements to the latching mechanism by which the totes in each of the rows are connected to each other.

### BRIEF DESCRIPTION OF THE DRAWINGS

FIG. 1 is an illustration showing an exemplary configuration of the storage system of the present invention.

FIG. 2 shows more detail of a portion of the storage system shown in FIG. 1.

FIGS. 3(a-l) is a series of schematic diagrams showing the pseudo-continuous movement of the totes is here shifted from one row to another.

FIG. 4 is a transparent illustration of one embodiment of a tote in accordance with the present invention.

FIG. 5 shows one embodiment of a tote coupling mechanism.

FIG. 6 is an illustration of one embodiment of the carrier.

FIG. 7 is an illustration of a continuous drive mechanism in accordance with the present invention

FIG. 8 is an illustration of the lifting mechanism which is part of the continuous drive mechanism.

FIG. 9 is an illustration showing a carrier which is moved underneath a cantilevered portion of a row in the storage structure.

FIG. 10 is an illustration of the acceleration drive mechanism.

FIG. 11 is an illustration of internal portions of the acceleration drive mechanism.

FIG. 12 is a side view of the internal structure of the acceleration drive mechanism, showing the configuration of the drive belt

FIG. 13 is an illustration of the side shift mechanism.

FIG. 14 is an illustration of a portion of the storage structure showing the area where the intake/output structure is located.

FIG. 15 is an illustration showing the intake/output structure in situ on the storage structure

FIG. 16 is an illustration of an input ramp which is part of the intake/output structure.

FIGS. 17(a-b) are illustrations of the lifting mechanism for lifting a tote from the picking area to an input ramp.

FIG. 18 is a top view of a picking station and an intake and output ramp.

FIGS. 19-20 are illustrations of an intake/output structure showing output buffer ramps, input buffer ramps, and vertical conveyor.

FIG. 21 is an illustration of a carrier showing multiple ways of loading and unloading a tote for intake into or output from the storage system.

FIG. 22 is an illustration of the transfer of a tote from a first carrier to a second carrier.

FIG. 23 is an illustration of the movement of a tote from a row in the storage structure to an output row via a carrier.

FIG. 24 is an illustration of the use of conveyors disposed on the ends of the storage structure for the output of totes from the storage system, wherein carriers are used to transfer the totes from the storage system to the conveyors.

FIG. 25 is an illustration of the use of conveyors for intaking totes into the storage system, wherein the totes are transferred from the conveyor to the storage system via the carrier using a pusher mechanism.

FIGS. 26(a-g) are illustrations of the steps of a process of moving a tote from the conveyor to a carrier utilizing a push mechanism.

FIGS. 27(a-e) are illustrations of the steps of a process of moving a tote from the conveyor to a carrier using a pusher mechanism, wherein t carrier utilizes a stopping plate to stop the motion of the tote along the conveyor.

FIG. 28 is an illustration of the components for utilizing a stopping plate to align the tote with the carrier, wherein the components are attached to and mobile with the carrier.

FIG. 29 is an illustration of a configuration utilizing segmented carriers, wherein the carrier can transfer totes and move between the segments of the conveyor.

FIGS. 30(a-b) are illustrations of carriers which are integrated with the belt portion of the conveyor such as to allow free movement of the carrier along the conveyor and further wherein multiple carriers are utilized on a single conveyor.

FIGS. 31(a-b) and FIG. 32 are illustrations of one embodiment of a retention mechanism.

FIGS. 33(a-f) are illustrations of the operation of a shifting mechanism for shifting a single tote from a first to a second position.

FIG. 34 is a logical block diagram showing the components of the carrier.

FIG. 35 is a schematic diagram showing two rows of storage structure being serviced by a primary and secondary carrier to illustrate the coordination between the primary and secondary carriers.

FIG. 36 is a flowchart showing a high-level process for retrieving a tote using a single, primary carrier.

FIG. 36A is a flowchart addition to the flowchart of FIG. 36 incorporating a secondary carrier.

FIG. 37 is a schematic illustration of a carrier showing the various drive mechanisms thereon.

FIG. 38 is a detailed flowchart showing the first phase of the process of moving a tote from a source row to a destination row.

FIG. 39 is a detailed flowchart showing the second phase of the process of moving a tote from a source row to a destination row.

FIG. 40 is a detailed flowchart showing the third and fourth phases of the process of moving a tote from a source row to a destination row.

FIG. 41 is a flowchart showing a high-level process for storing a tote in a row.

FIG. 42 is a flowchart showing a special case of a high-level process for storing a tote in a row in which the carrier extends the entire length of a layer of the storage structure.

### DEFINITIONS

As used herein, the term “carrier” refers to a locally or remotely controlled robotic mechanism capable of moving about a tote support and storage structure in a vertical, horizontal or both vertical and horizontal directions and capable of accepting, carrying and discharging one or more totes from a source row to a destination row or from an intake of the storage structure or to an output of the storage structure.

As used herein, a “tote” refers to a device capable of carrying goods for transport by a carrier from one location to another. The tote may be configured to be manipulated by a carrier for purposes of movement from a storage location to and from an exit or entry point of the storage system. The tote may be configured as a container, as a flat structure on which other containers may be placed, or as a flat structure from which goods may be hung.

As used herein, the term “storage structure” refers to a structure for storing totes and facilitating the placement and retrieval of totes within the storage structure by one or more carriers.

As used herein, the term “layer” refers to multiple rows for the storage and retrieval of totes. Layers can be oriented in a horizontal, vertical, or any orientation within the storage structure.

As used herein, a “row” is defined as a portion of a storage structure capable of storing a plurality of totes aligned longitudinally with each other and able to move in the longitudinal direction of the row. A row may be horizontal, vertical, or any orientation within the storage structure, but horizontal orientation is the preferred embodiment, because the force to pull a row of totes in the horizontal direction is significantly less than the force needed to lift the coupled totes in vertical direction.

As used herein, the term “constant velocity”, with respect to the movement of rows of totes, is defined as the movement of a row at a substantially constant speed or the continuous movement of a row at varying speeds after being accelerated from a stopped position or before being decelerated to a stopped position. The term “continuous drive mechanism” refers to a mechanism implementing the constant or continuous velocity movement of the row.

As used herein, the term “conveyor”, is defined as any system capable of moving objects from one place to another, as, for example, using belts, rollers or any other means. A conveyor could operate independently from a mobile carrier or as part of the mobile carrier. A mobile carrier could be considered a conveyor.

### DETAILED DESCRIPTION

The embodiments described herein utilize multiple carriers that work in unison to manipulate totes or other stored product from a storage structure, to efficiently retrieve a particular tote or store a tote. The process utilizes a system of totes or carriers that allow for force to be shared between a row of totes in a singular linear direction along a longitudinal axis of a row (in either positive or negative directions) and also allows for the totes to be decoupled by moving them in a direction orthogonal to the direction of the longitudinal axis of the row (either positive or negative or up or down directions). The novel technology can manipulate the totes or other products in both directions to move a target tote (and as a result, all totes coupled to the target tote) toward an end of the row where it may be decoupled from the row.

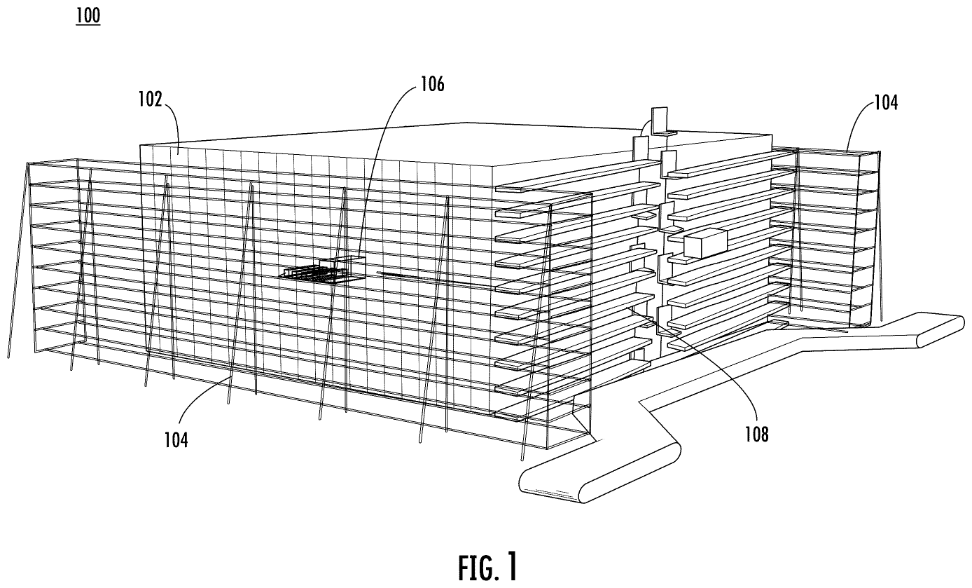

An exemplary storage structure 100 is depicted in FIG. 1. The structure consists of multiple layers of rows 102 containing totes, wherein the totes in each row 102 are coupled to each other to allow movement of the entire row by providing a pushing or pulling force on the tote at the end of the row. Carrier servicing area 104, disposed along opposite sides of the storage structure 100, guide one or more carriers 106 to the ends of rows 102 where the totes are to be manipulated. An intake/output structure 108 may be disposed anywhere within or outside of the structure 100 to facilitate the intake of totes into the system and the output of totes from the system. FIG. 1 shows only one possible embodiment of the system; many variations of the structure and configuration are possible and are considered to be within the scope of the invention.

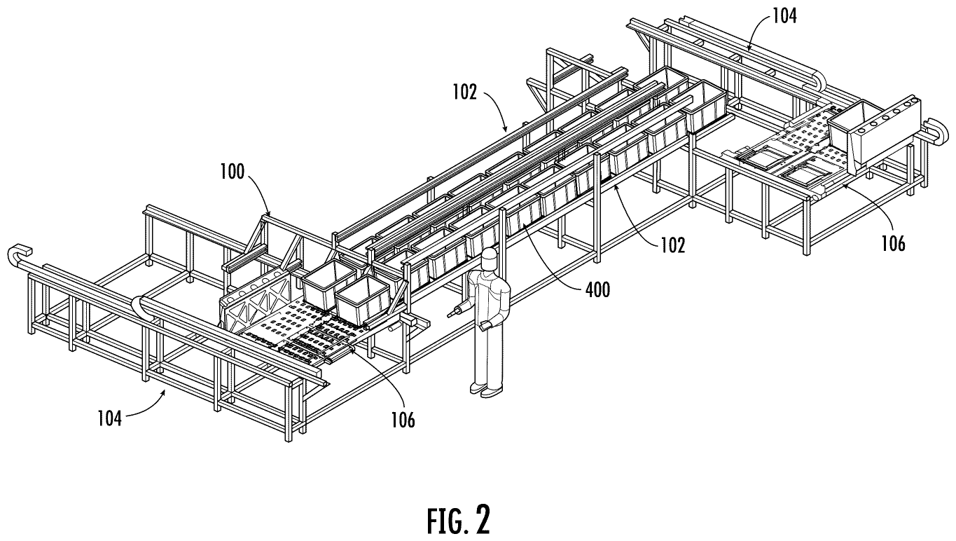

FIG. 2 shows a portion of storage structure 100. The portion shows two rows 102 containing only ten totes 400 per row. However, as would be realized by one of skill in the art, the length of each row 102, and therefore the number of totes 400 that may be stored in a row 102, may be limited only by the ability of the drives to provide the pushing or pulling force necessary to move the entire row of totes, including the weight of the goods contained in each tote. Carriers 106, disposed at either end of the rows 102 may move along carrier servicing area 104 such as to align with rows in the structure 100. Carriers 106 include three types of drive mechanisms which provide the forces necessary to shift totes 400 between rows of storage structure 100. These include continuous drive mechanisms 602, acceleration drive mechanisms 604 and side shift mechanisms 606. The various types of drive mechanisms will be discussed in more detail later. Carriers 106 have the capability of carrying out high-level commands received from a central control autonomously. This entails being able to move to a specific row or rows, aligning itself with the rows, controlling various types of drives 602, 604, 606 thereon to affect the pseudo-continuous motion and pairing and communicating with a other carriers 106.

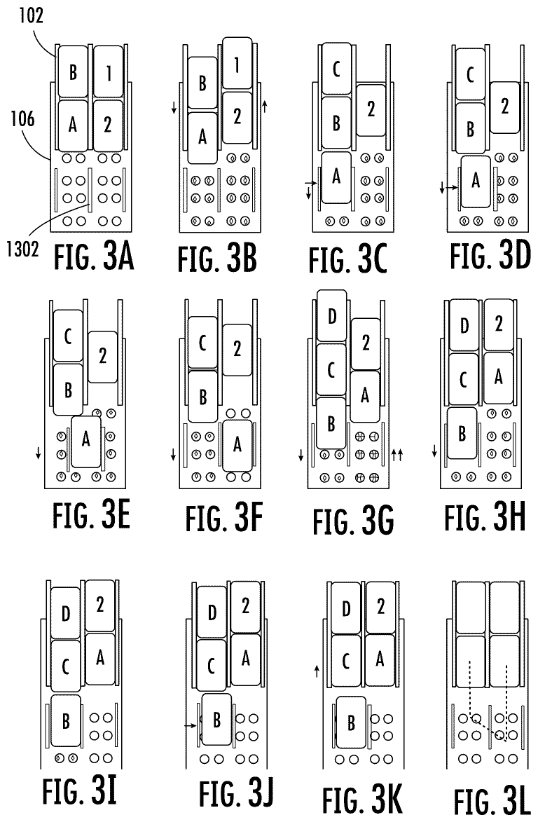

FIGS. 3(a-l) are schematic illustrations of the process by which totes are shifted from one row to another using the pseudo-continuous motion of the present invention. The box labeled 106 in FIG. 3(a) represents carrier 106 in all of FIGS. 3 (a-l) and the lines between the totes represent source row 102 and destination row 104. The series of illustrations will show the movement of totes labeled “A” and “B” from the source (left) row 102 to the destination (right) row 104. FIG. 3(a) shows carrier 106 in position at the end of a source row 102 and a destination row 104 of storage structure 102. A continuous drive mechanism located in carrier 106 engages tote “A” and as shown in FIG. 3(b), provides a pulling motion which moves the entire source row 102 in direction “X”. At the same time, or at a pre-determined time thereafter, a carrier on the opposite end of the rows engages a tote at the end of the destination row 104 and moves the entire destination row 104 in direction “Y”. The movement of the source row 102 in direction “X” and the movement of the destination row 104 in direction “Y” occur at a constant velocity. FIG. 3(c) shows tote “A” clear of storage structure 100 and completely on the carrier 106. Once the tote is clear of the storage structure 100 the tote is free to be shifted from one the source row 102 to the destination row 104. Totes are shifted from the source row 102 to the destination row 104 using a side shift drive mechanism the details of which will be discussed later. In addition, totes can be moved in direction “X” or “Y” while on carrier 106 via the acceleration drive mechanism, which will also be discussed later. As tote “A” is being pulled from the source row 102 by the continuous drive mechanism, the acceleration drive mechanism on both the left side and right side of carrier 106 matches the speed and direction of the continuous drive mechanism. In FIG. 3(d), tote “A” has begun its shift from the left side of carrier 106 to the right side of carrier 106, such as to be aligned with destination row 104. The process of shifting in a direction orthogonal to the row automatically decouples tote “A” from the source row 102, as will be discussed later. FIG. 3(e) shows tote “A” at the halfway point between the left side of carrier 106 and the right side of carrier 106, while still maintaining a constant velocity in direction “X”. In FIG. 3(f), tote “A” is completely aligned with the destination row 104 and the acceleration drive mechanism on the right side of carrier 106 reverses direction and accelerates tote “A” in direction “Y” at a faster rate than the continuous drive mechanism is pulling the destination row 104 in direction “Y”, such that tote “A” “catches up” with destination row 104 and couples to tote “2”. The actual path of the tote as it moves from source row 102 to destination row 104 is shown in FIG. 3(l). Of particular interest is the diagonal motion of tote “A” as it is shifted from the left side of carrier 106 to the right side of carrier 106. Also note, as shown in FIG. 3(f), tote “B” is almost out of source row 100 and positioned on the left side of carrier 106. As shown in FIG. 3(g), tote “B” enters the left side of carrier 106 as tote “A” is exiting carrier 106 and being moved into destination row 104. FIGS. 3(h-k) show the same processes as described above for moving tote “B” into destination row 104.

Note that once tote “B” is completely aligned with the right row, the continuous drive mechanism and acceleration drive mechanism on the left side of the carrier cease movement to avoid pulling tote “C” out of the left row. The pseudo-continuous motion provided by the different types of drives on carrier 106 optimizes the efficiency of the movement of the totes into and out of the rows to provide access to a tote-of-interest located on the interior of the rows in a more efficient manner.

### Tote Configuration

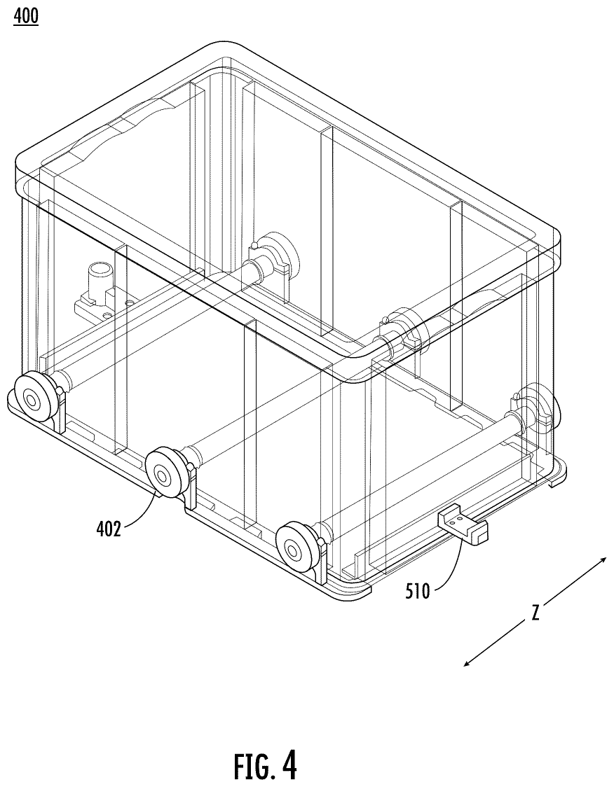

The configuration of totes 400 will now be discussed. A first embodiment of the tote is shown in FIG. 4, wherein the tote embodies a container structure 400 for accepting goods for storage. In an alternate embodiment of the invention, tote 400 may be configured as a flat platform which can accept goods or containers for goods stacked thereon.

As shown in FIG. 4, tote 400 is configured with a series of wheels 402 on opposite sides thereof to allow movement of the tote along a longitudinal axis of each row. In one embodiment, shown in FIG. 4, wheels 402 are mounted above the bottom surface of tote 400 and engage parallel tracks disposed on either side of each row. In one embodiment, the tracks may be “C-shaped” at support the wheels 402 in both the up and down directions. In another embodiment, not shown, wheels 402 may be disposed near the top surface of tote 400 and would engage the parallel tracks such that tote 400 would hang from the track. In such cases, the tote may be configured as, for example, a flat carrier having a mechanism to engage hanging goods such as clothing. In some embodiments, the wheels may be disposed not on the totes, but in the rows of storage structure 100, wherein the totes ride on the wheel in the rows. IN yet other embodiments, other means may be employed to minimize frictional between the totes and storage structure 100.

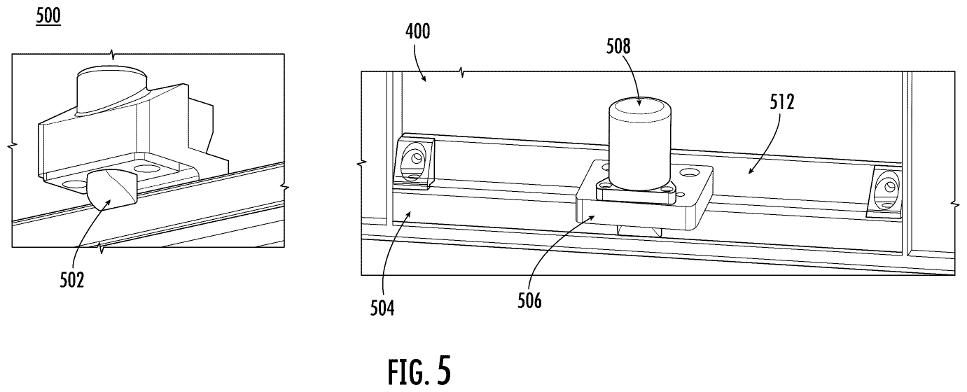

In a second aspect of the invention, totes 400 are configured with a coupling mechanism 500 that automatically engages as totes 400 are moved together. FIG. 5 shows one embodiment of the coupling mechanism. In this embodiment, a first portion of the coupling mechanism 500 comprises a spring-loaded latch 502 having an angled surface that pushes up when the spring-loaded latch 502 encounters a hook mechanism 510, shown in FIG. 4. In one embodiment, coupling mechanism 500 is securely attached to the body of tote 400 via a mounting plate 506 which is securely attached to support structure 504 which in turn is attached to the body of tote 400. Coupling mechanism 500 may include a dust cover 508 and the spacing may be adjusted utilizing a spacer 512 to reinforce the tote wall. In other embodiments of the tote, other configurations are possible. For example, the entire coupling mechanism support structure could be part of the molded plastic from which the tote is constructed.

De-coupling of totes 400 occurs when one tote is moved in a direction orthogonal to the longitudinal line of the row 102, that is, tote 400 is moved towards another row 102 in storage structure 100. As noted in FIG. 4, the edges of hook mechanism 510 are not closed (like the edge portion) such that movement of the tote in either direction indicated by the arrow “Z” will cause hook mechanism 510 to disengage from spring-loaded latch 502, thus decoupling the totes. Thus, as the tote moves from one row to another row, as shown in FIGS. 3 (d-e), the tote is automatically decoupled from the adjacent tote in the row. By the time the tote has reached position shown in FIG. 3(e), the tote is completely decoupled from the adjacent tote.

In one alternate embodiment, the totes may be configured with a coupling mechanism 500 and a hook mechanism 510 on each side of the tote, such that the totes may be bidirectionally inserted into and removed from rows 102.

As would be realized by one of skill in the art, the coupling mechanism 500 and hook mechanism 510 just described are only exemplary in nature, and that many other possible mechanisms for coupling and decoupling the totes are contemplated to be within the scope of the invention.

### Carrier Configuration

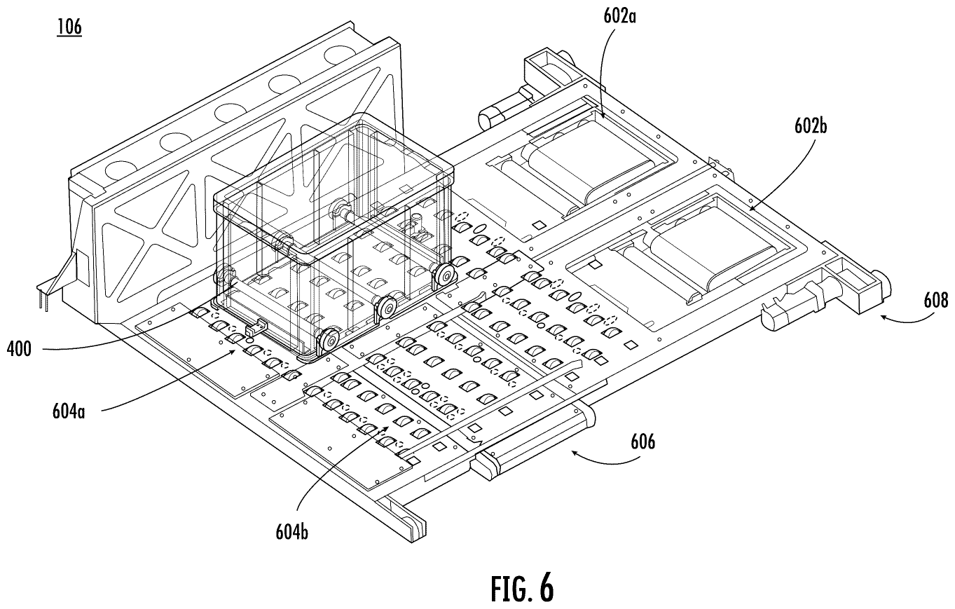

An exemplary configuration of carrier 106 is shown in FIG. 6. In this embodiment, carrier 106 is two rows wide, with one side spaced such as to receive a tote 400 from one row 102 and the other side spaced such as to deposit the tote 400 in an adjacent row 102. In other embodiments of the invention, the carriers may be multiple rows wide, with each row configured as shown in FIG. 6. In an extreme embodiment, carrier 106 may be configured to cover the entire length of the edge of storage structure 100. In yet another embodiment, carriers 106 may be configured to transfer a tote 400 from one carrier 106 to an adjacent carrier 106.

The carrier may be configured with continuous drive mechanisms 602a, 602b. Continuous drive mechanisms 602a, 602b are bi-directional drives which are configured to engage the end tote in a row 102 such as to pull a series of coupled totes 400 from the row 102 or to push a series of coupled totes 400 into the row 102, depending on the direction of motion of the conveyor belt. In various embodiments, the engagement between the continuous drive mechanisms and the totes may be a frictional engagement or may be a positive engagement, for example, with a rack and pinion arrangement. Preferably, continuous drive mechanisms 602a, 602b pull the totes 400 from a row 102 or push the totes 400 into row 102 at a constant velocity which is the same for both of continuous drive mechanisms 602a, 602b.

Carrier 106 is also configured with acceleration drive mechanisms 604a, 604b, one for each of the rows 102. Acceleration drive mechanisms 604a, 604b are bi-directional drive mechanisms capable of moving totes 400 at a velocity equal to constant velocity drive 602a, 602b, or to accelerate a tote 400 such as to couple it to an adjacent tote 400 that is being moved into a row 102, in which case, the tote must be accelerated to a speed faster than the speed of the continuous drive mechanism.

Lastly, carrier 106 is provided with a side shift drive mechanism 606 which is capable of moving totes 400 from one row to another, even as they are being moved in a direction parallel to a longitudinal line of each row 102.

In some embodiments, carrier 106 may be provided with a carrier drive 608 capable of moving carrier 106 within carrier servicing area 104 to align carrier 106 with different rows 102 of storage structure 100. In some aspects of this embodiment, the carrier 106 may be limited to movement within one layer of storage structure 100. In other aspects of this embodiment, the carrier 106 may be configured with a drive mechanism capable of moving carrier 106 between layers of storage structure 100.

Carrier 106 may be provided, in various embodiments, with a plurality of sensors both for providing an identification of a tote 400 via, for example, a barcode mounted on the tote 400, and for sensing the position of a tote 400 on carrier 106.

### Continuous Drive Mechanism

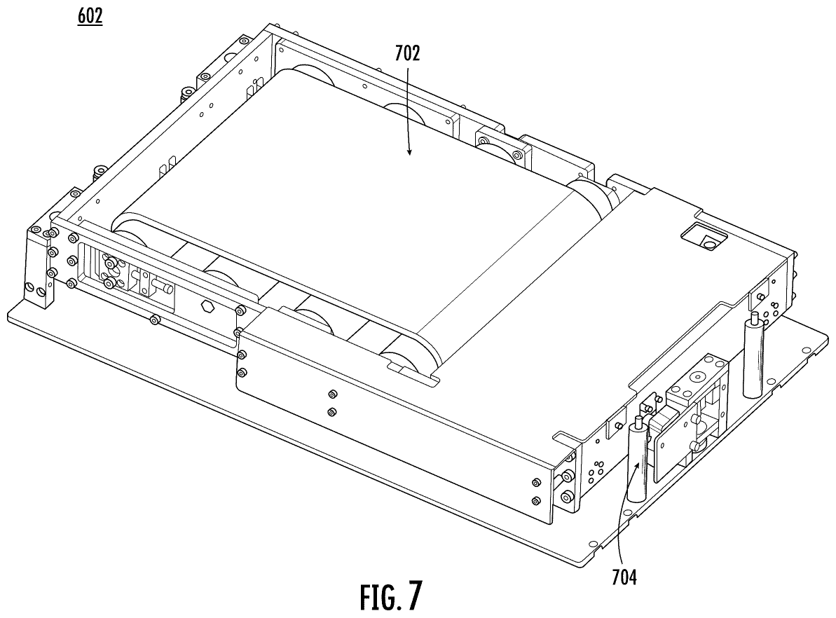

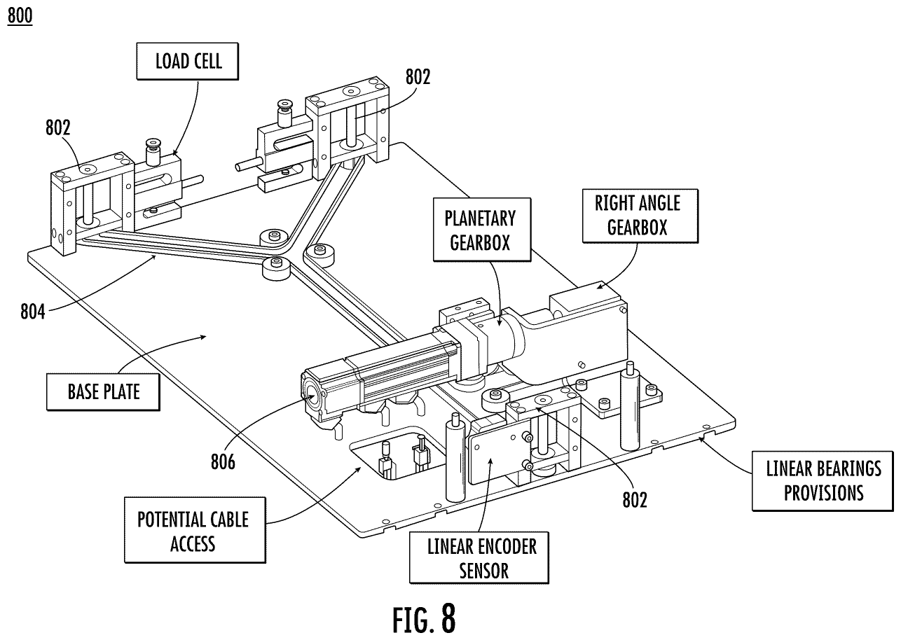

Continuous drive mechanism 602, shown in perspective view in FIG. 7 is designed to continuously move totes 400 from a row 102 onto carrier 106 and to move totes 400 on carrier 106 into a row 102. Preferably, continuous drive mechanism 602 will keep the row moving continuously at a constant velocity to avoid having to accelerate or decelerate the row, until the tote-of-interest is loaded onto carrier 106. Keeping the row of totes 400 moving at a constant velocity saves energy and time that would otherwise be used in accelerating and decelerating the row as totes are removed from or inserted into a row 102. As such, the source row and a target row are in continuous motion until a tote-of-interest is retrieved from the interior of the source row and is positioned on carrier 106.

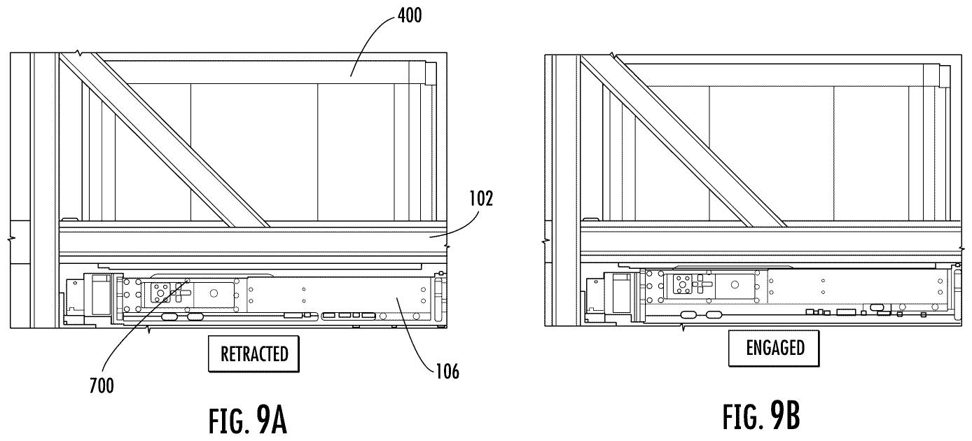

In one embodiment, the continuous drive mechanism 602 frictionally engages a tote. Drive mechanism 704 drives conveyor 702 at the constant velocity once the frictional engagement with tote 400 has been made. FIG. 8 shows a lift mechanism 800 for raising the conveyor 702 such that it is ready to frictionally engage with the bottom of tote 400. In one embodiment, the lift mechanism 800 consists of three ball screws 802, driven by belt 804. When belt 804 is actuated by motor 806, ball screws 802 are rotated and move upward, thereby lifting conveyor 702 upward and into frictional contact with tote 400. FIG. 9 (a) shows the continuous drive mechanism 602 disengaged from tote 400, while FIG. 9 (b) shows a continuous drive mechanism 602 frictionally engaged with tote 400. In various other embodiments, other lift mechanism configurations may be used. For example, a cam-based lifting mechanism could be used. In one embodiment, the entire carrier could act as the lifting mechanism to lift the continuous drive mechanism into engagement with the tote. In alternate embodiments, the continuous drive mechanism 602 may engage a tote via a mechanical engagement.

It should be noted that rows 102 are cantilevered out from storage structure 100 such that carrier 106 can move underneath the cantilevered portion of each row 102 to engage the tote 400 at the end of the row 102. Once carrier 106 is in position and aligned with the row, the continuous drive mechanism 602 is raise as described with respect to FIG. 6 and is then ready to frictionally engage a tote. Note that a tote may already be present above the continuous drive mechanism 602 or may be pushed out of the row at a later time. FIG. 9 shows carrier 106 with the continuous drive mechanism 602 portion of the carrier 106 located underneath the cantilevered portion of rows 102. Once carrier 106 is ready to move laterally such as to align with another row, the continuous drive mechanism 602 is lowered as described with respect to FIG. 6.

### Acceleration Drive Mechanism

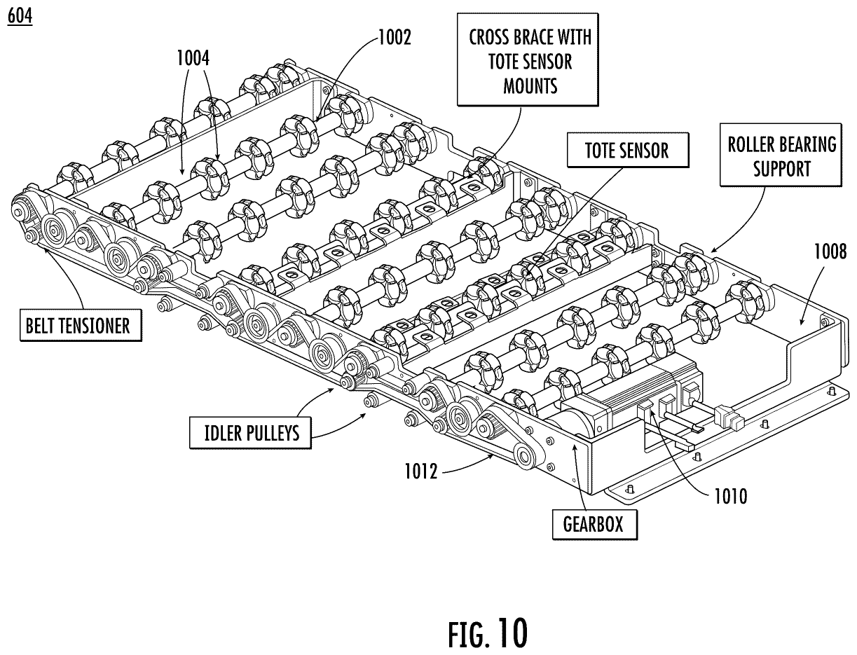

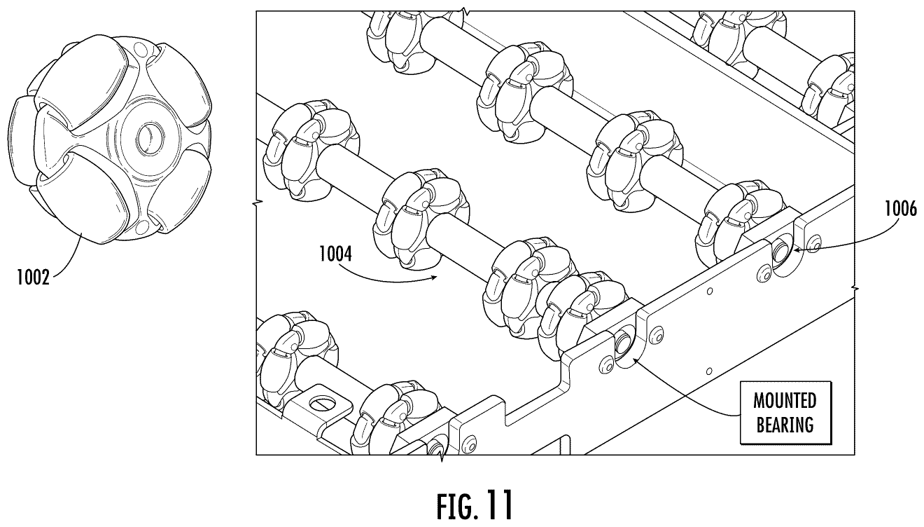

Acceleration drive mechanism 604, shown in FIG. 10 and FIG. 11 consists of a series of Omni casters 1002 mounted in pairs on axles 1006 and separated by spacer tubes 1004. Omni casters 1002 are commercially available off-the-shelf components which, when rotated, engage the bottom surface of tote 400 to move it in the direction parallel to the longitudinal lines of each row 102 of storage structure 100. Axles 1006 are mounted in frame 1008 and driven by motor 1010 via belt 1012. Acceleration Drive mechanism 1000 is bidirectional in that it can accelerate totes 400 in either direction. Omni casters 1002 also allow a near-frictionless side-to-side motion of totes 400 as they are being accelerated away from a source row 102 or towards a target row 102. This allows the tote 400 to follow the diagonal path shown in FIG. 3(l). In one embodiment, omni casters 1002 are provided in pairs such that the tote is always in contact with the portion of an Omni caster 1002 to allow the side-to-side motion.

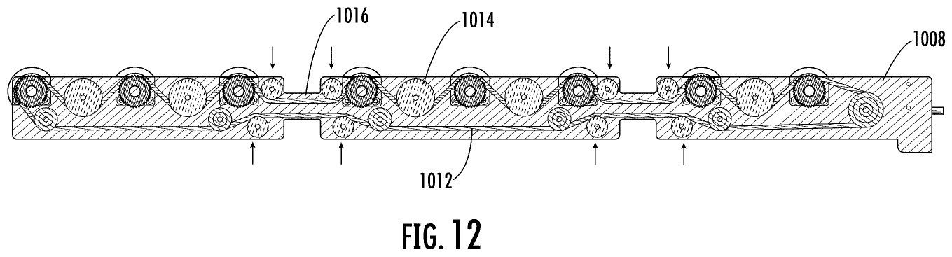

FIG. 12 shows a side view of the acceleration drive mechanism 604 showing belt 1012 disposed around a series of pulleys 1014 to provide the force to rotate axles 1006. Notches 1016 in frame 1008 allow space for the side shift drive mechanism 606, discussed next, to integrate with the acceleration drive mechanism 604.

### Side Shift Drive Mechanism

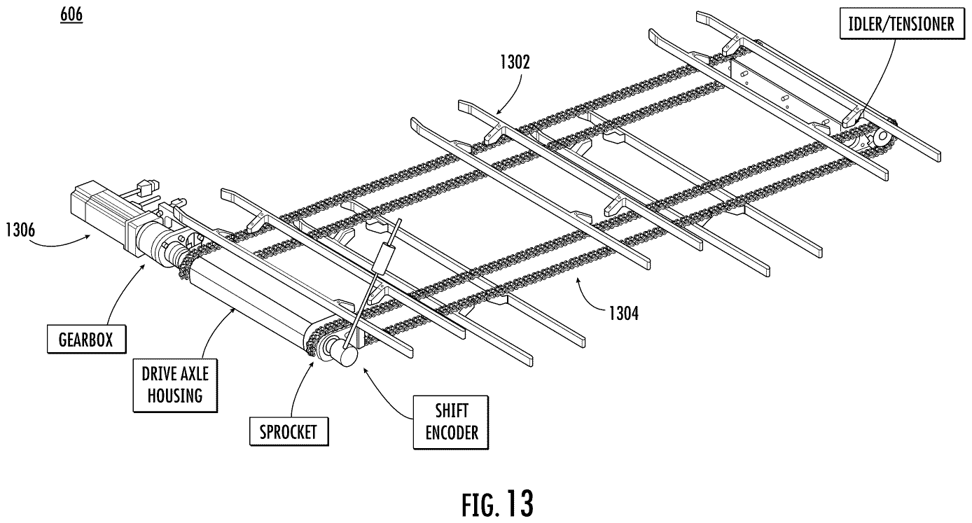

FIG. 13 shows the side shift drive mechanism 606. The purpose of side shift drive mechanism 606 is to push totes 400 from one row on carrier 106 to another row on carrier 106. It should be noted that side shift drive mechanism 606 can be of any length, depending upon the length of carrier 106, and may be capable of shifting totes 400 multiple rows.

Side shift drive mechanism 1300 consists of a set of grousers 1302 driven by a belt or chain 1304. Belt or chain 1304 is driven by motor 1306 via a drive axle. Grousers 1302 move to engage the sides of totes 400 and push the totes 400 in either of the directions indicated by arrow “Z” in FIG. 4. Grousers 1302 are indicated by vertical lines shown in each of FIGS. 3(a-k). Side shift drive mechanism 606 integrates with two or more acceleration drive mechanisms 1000. Chain or belt 1304 fits into slots 1016, shown in FIG. 12.

### Tote Input/Output

In addition to retrieval, storing and shuffling of totes, the storage structure must be capable of outputting a tote from storage structure 100 and intaking a tote into the storage structure 100. In one embodiment, outputting a tote from the storage structure 100 is accomplished by delivering the tote to an output row in the layer of storage system having a downward slope which allows the tote to be gravity fed to either a vertical conveyor located near a pick station of the storage system 100 or to a carrier on a lower level of storage structure 100 which can deliver the tote to the vertical conveyor or, alternatively, to another downward sloped row. In other embodiments, the tote may be output from storage structure 100 by moving it to a level output row having a powered component for moving the tote along the row. Inputting a tote into the storage system is accomplished by delivering the tote via the vertical conveyor to a row in a layer of storage system 100 one layer above the intended target layer and inserting the tote in a row having a downward slope which allows the tote to be gravity fed to the target layer. In certain embodiments of the invention, the gravity feed is accomplished by a row having a slope of approximately 2.5° degrees, however, other degrees of slope may be used.

One possible embodiment of such an intake/output structure is shown in FIG. 1 as reference 108, which shows the intake/output structure located at the end of storage structure 100. As would be realized by one of skill in the art, the intake/output structure 108 could be located at any row 102 within the layer of storage structure 100 and, in fact, the intake/output structure 108 could be located in different rows for different layers of storage structure 100.

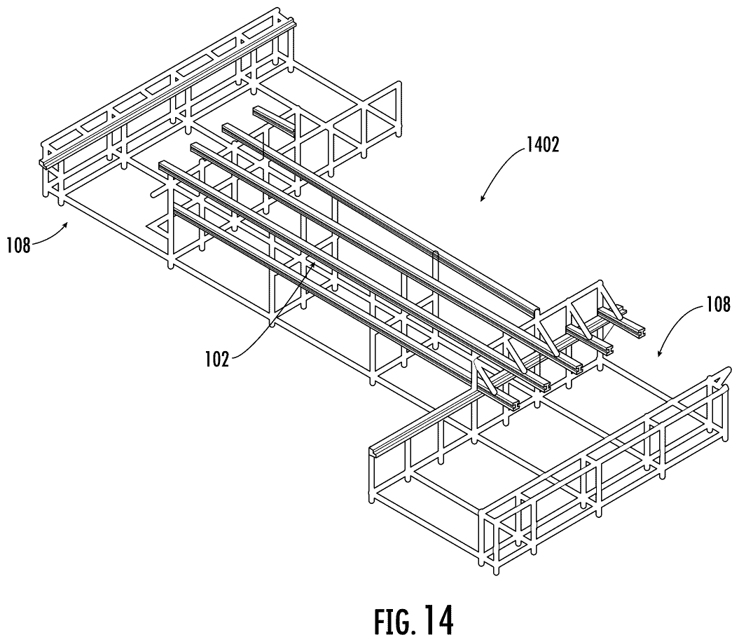

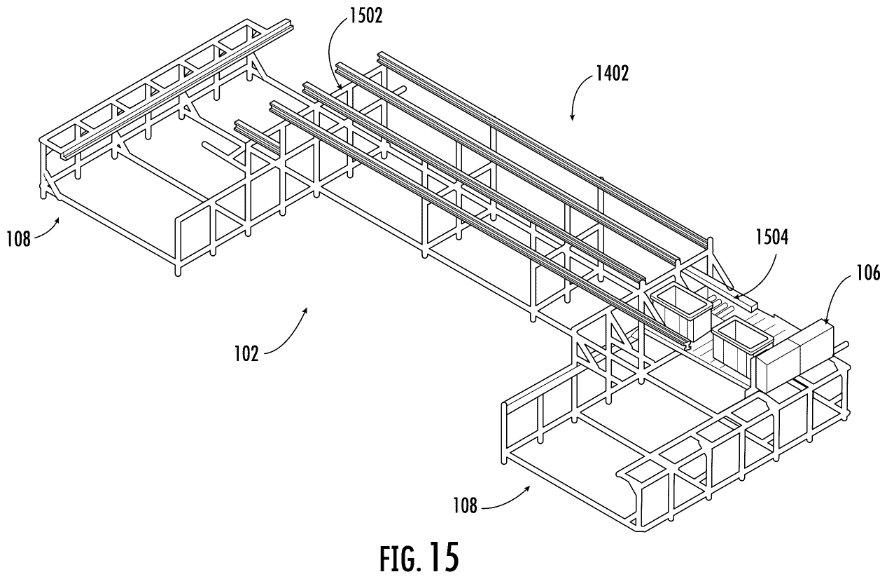

FIG. 14 shows a portion of storage structure 100 having storage rows 102 and carrier servicing areas 108 indicated. The area indicated by reference number 1402 is the area for this layer of the storage system wherein the intake/output structure 108 is to be located. FIG. 15 shows one possible embodiment of intake/output structure 108 for a single row of storage structure 100. Intake/output structure 108 includes row 1502 which allows totes from the next highest layer in the storage structure to be gravity fed to the current layer in the storage structure and row 1504 which allows totes at the current layer is in the storage structure 100 to be gravity fed to the next lowest layer in the storage structure 100. As such, there are two ways to intake and output totes from the storage structure. The first method for outputting totes is a layer-by-layer method in which totes are gravity fed to the next lowest layer and transferred via carrier 106 to another row in the storage structure which in turn gravity feeds the tote to the next lowest layer in the storage structure, until the tote has reached the lowest layer of the storage structure, where it is transferred to a pick station. The second method is by inserting the tote into a row which gravity feeds the tote to a vertical conveyor which then transports the tote to the level of the storage structure and, ultimately, to a pick station.

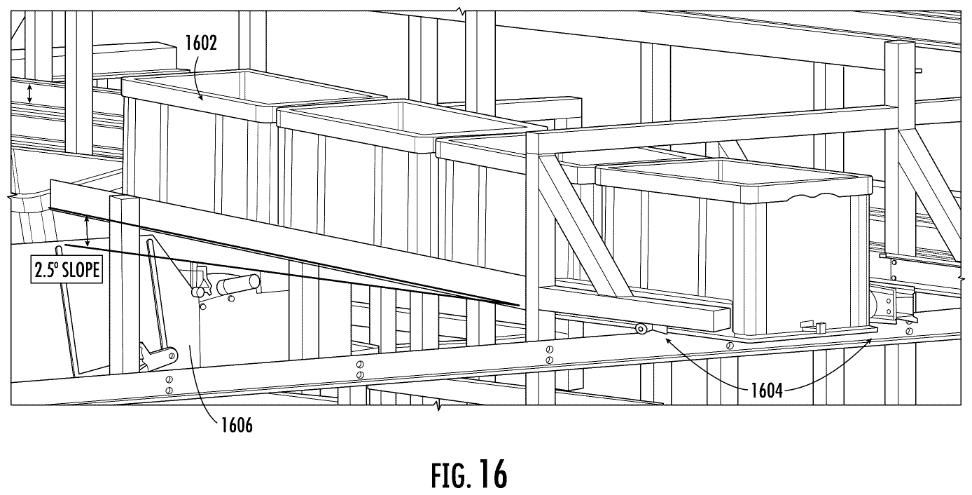

FIG. 16 shows an exemplary intake row of storage structure 100. Totes may be lifted from a pick station by lifting mechanism 1606 to the intake row 1602 and queued within the intake row 1602 until a carrier 106 can load the end tote and transport it to a vertical conveyor, which then lifts the tote to its destination layer (or to a layer above the target layer where the tote is inserted into a downward sloped row to gravity feed the tote to its target layer). It should be noted that while totes are queued in intake row 1602, and because the totes are gravity fed within the row, the end tote must be retained by a retaining mechanism 1604 until a carrier 106 is available to remove the tote from intake row 1602. The retention mechanism 1604 will be discussed later.

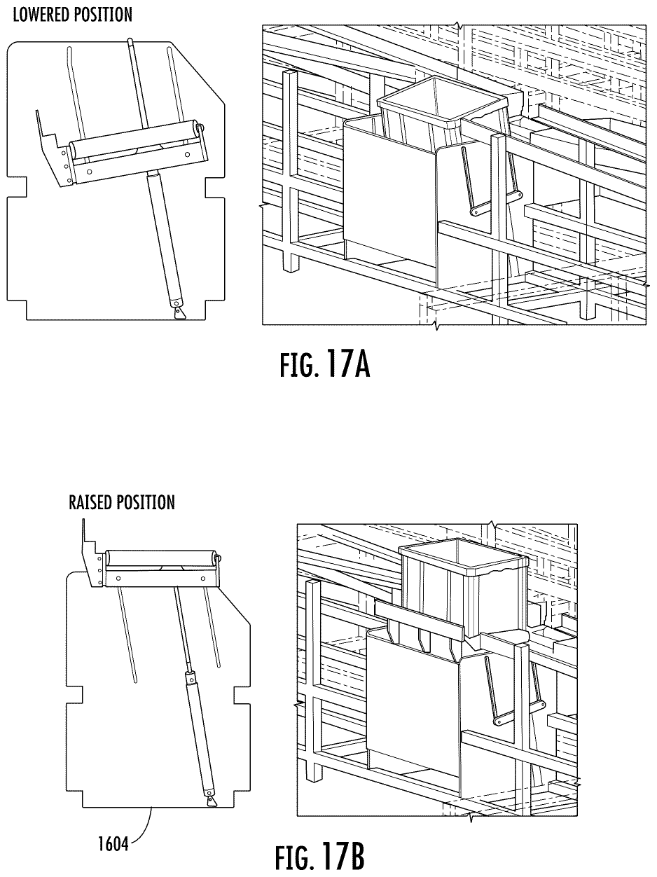

FIG. 17 shows one possible embodiment of a lifting mechanism 1606 which lifts the tote from a pick station to an intake row 1602 for input to the storage system 100. The tote is placed into the lifting mechanism 1606, which is shown in its lowered position in FIG. 17 (a). The tote is then raised, as shown in FIG. 17 (b) to a level where it can be pushed into intake row 1602. The lifting mechanism 1606 shown in FIG. 17 is exemplary and only and, as would be realized, many other possible configurations of lifting mechanism 1606 are possible without departing from the scope of the invention.

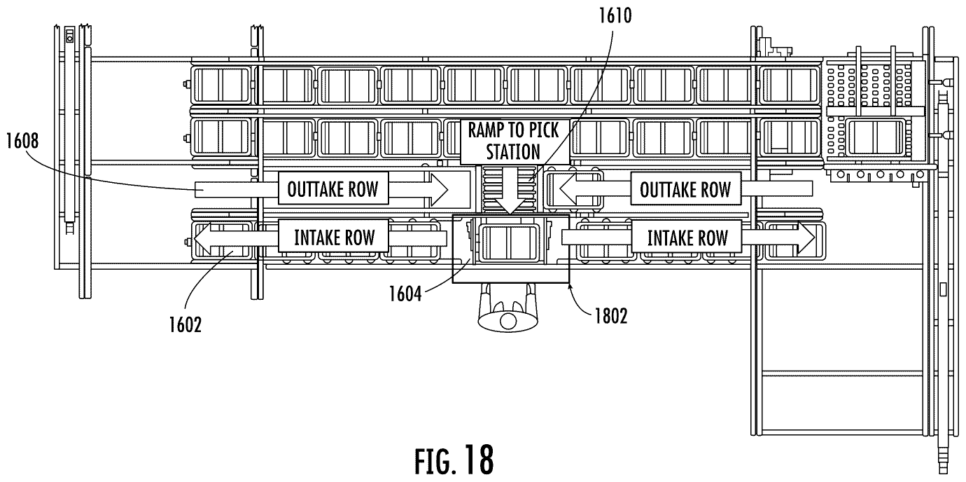

FIG. 18 shows an overhead view of an intake and output row of storage structure 100 at the lowest level with the pick station 1802 is located. To intake a tote in the storage system 100, the worker places the tote in lifting mechanism 1606, which lifts the tote to the level of intake row 1602. Once the tote is queued within intake row 1602, it is gravity fed downward until carrier 106 is available to pick the tote and transport it to vertical conveyor which lifts the tote to the higher layers of the storage system 100.

To output a tote from storage system 100, carrier 106 retrieves the tote either from a downward sloping row within the storage system or from a vertical conveyor and delivers it to output row 1608, where it is gravity fed via a series of rollers 1610 to pick station 1802, where it is retrieved by a worker and removed from storage system 100.

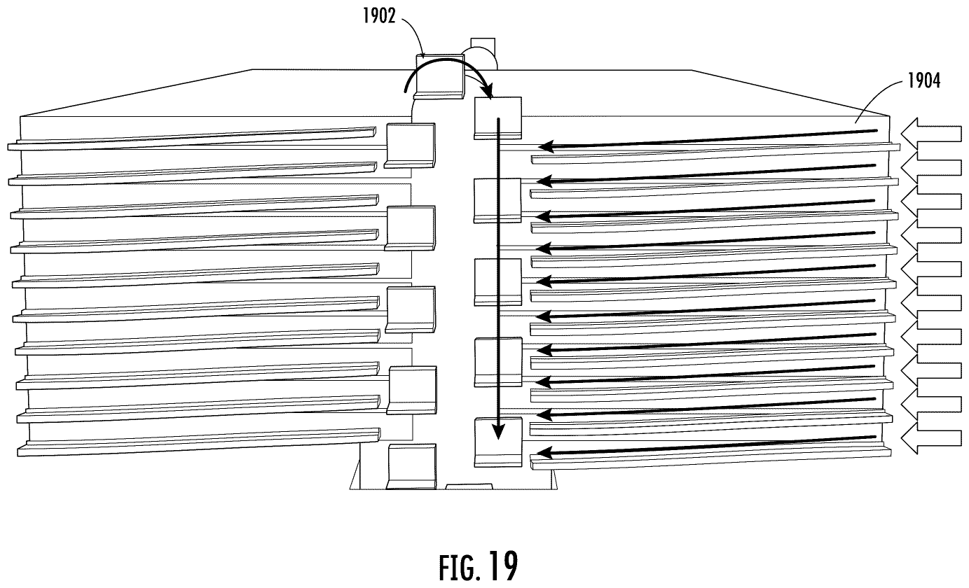

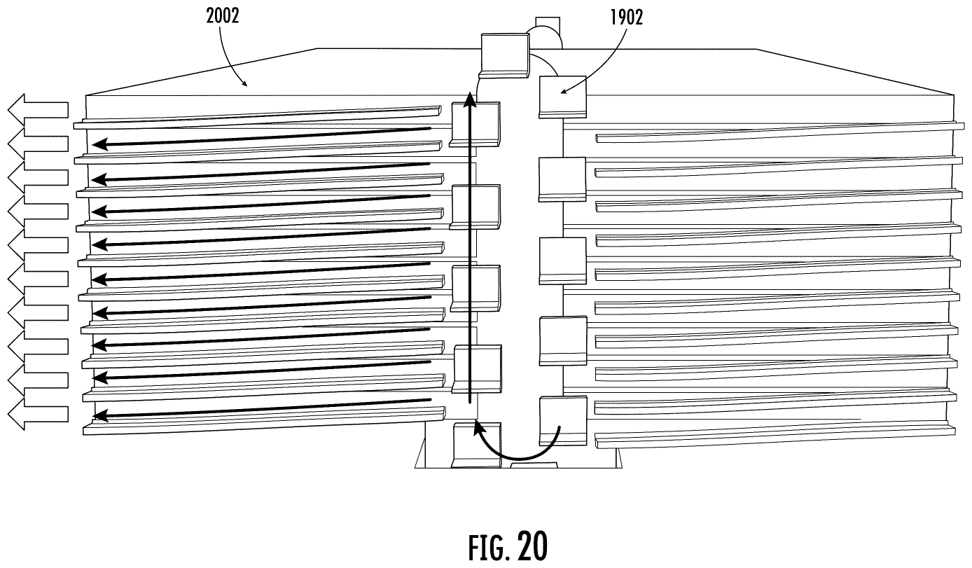

FIGS. 19-20 shows one exemplary embodiment of an intake/output structure 108. In this embodiment, totes are moved vertically via vertical conveyor 1902. When the tote is output from the system, it is placed on the end of one of output buffer ramps 1904 and moves by gravity feed down output buffer ramp 1904, where it is queued until a space on vertical conveyor 1902 becomes available. The totes must be retained at the end of output buffer ramp 1904 until an empty slot on vertical conveyor 1902 can be aligned with the end of output buffer ramp 1904. The vertical conveyor 1902 then moves the tote to the lowest level storage structure 100 where it is conveyed to a pick station 1802.

The input buffer ramp 2002 is shown in FIG. 20. Totes are lifted from the lowest level of storage structure 100 to a level one above the desired target level. The tote is pushed off of conveyor 1902 onto one of input buffer ramps 2002, where it moves by gravity feed down the ramp, where it waits in the queue to be picked up by a carrier 106 and delivered to the target row within the layer. As with the output buffer ramps 1904, when the tote reaches the end of input buffer ramp 2002, a retention mechanism must hold the tote in place until a carrier is available to remove the tote from the bottom of the ramp.

As be realized by skill in the art, the intake/output structure 108 may be located at any position on the end of or within the storage structure 100.

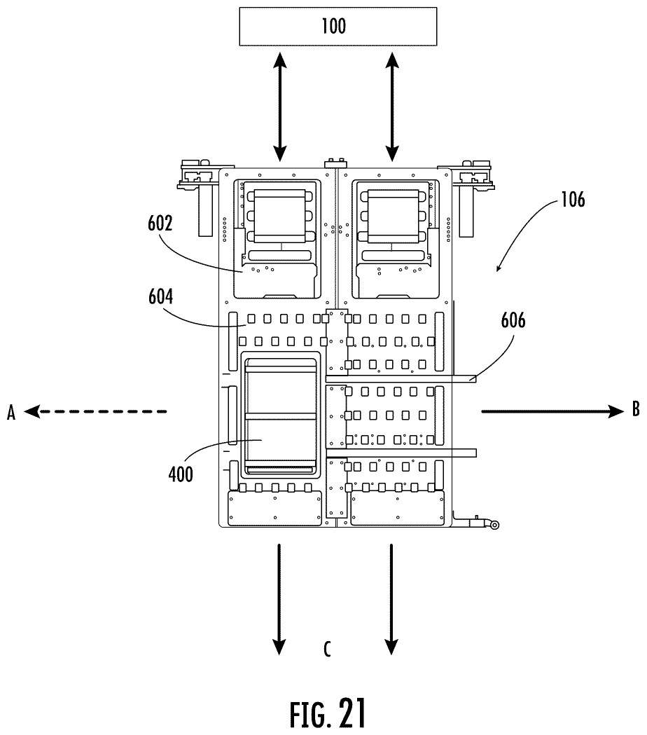

In one embodiment, the output of totes 400 from storage structure 100 may be accomplished by offloading the tote from carrier 106 to an output destination. Such an arrangement is shown in FIG. 21. Carrier 106 can move totes 400 to or from storage structure 100 using constant velocity driver mechanisms 602. Once a tote 400 is fully on carrier 106, instead of moving the tote 400 to another row within storage structure 100, the tote may be offloaded from carrier 106 to, for example, a conveyor belt, another carrier or any other possible destination. Once the tote 400 is fully on carrier 106, it may be offloaded in either of directions “A” or “B” using side shift mechanism 606. Alternatively, tote 400 may be moved in direction “C” from either the left or right rows utilizing acceleration drive mechanism 604.

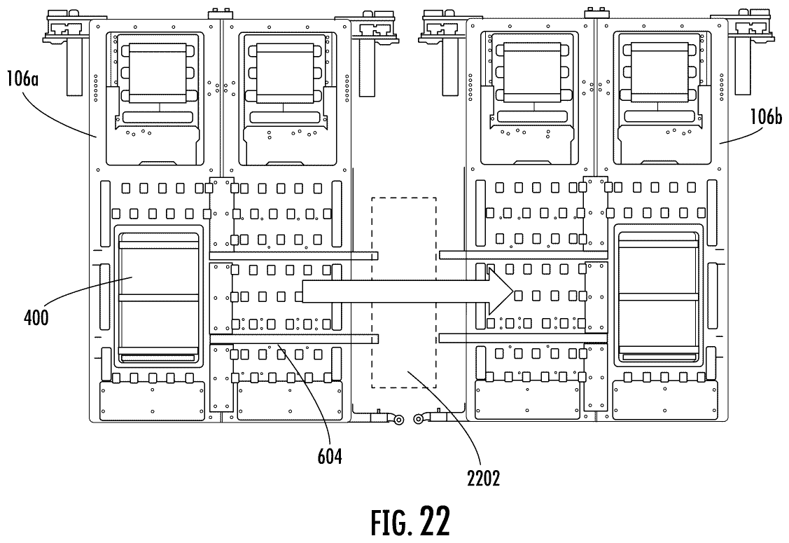

FIG. 22 shows an example of the movement of a tote 400 from a first carrier 106a to a second carrier 106b using side shift mechanism 604. In one embodiment, tote 400 may be required to cross transition area 2202 between carrier 106a and 106b. Transition area 2202 may be, for example, a low friction area, in which case tote 400 may be pushed by side shift mechanism 604 and may cross transition area 2202 by virtue of its own momentum. In other embodiments, transition area 2202 may be provided with a series of Omni casters 1002 to reduce the friction between transition area 2202 and tote 400. In some embodiments, transition area 2202 may be provided with its own side shift mechanism 604. In some embodiments, transition area 2202 may be a part of either of carriers 106a or 106b. In other embodiments, transition area 2202 may be stationary and disposed between the areas of storage structure 100 covered by carriers 106a and 106b respectively. In this case, carriers 106a and 106b may need to move to transition area 2202 to accomplish the transfer. In yet other embodiments, transition area 2202 may be eliminated and carriers 106a, 106b may be able to move close enough to each other to accomplish the transfer. In any case, as tote 400 and moves from first carrier 106a to second carrier 106b, it is desirable that the side shift mechanism 604 both carriers be moving at the same speed.

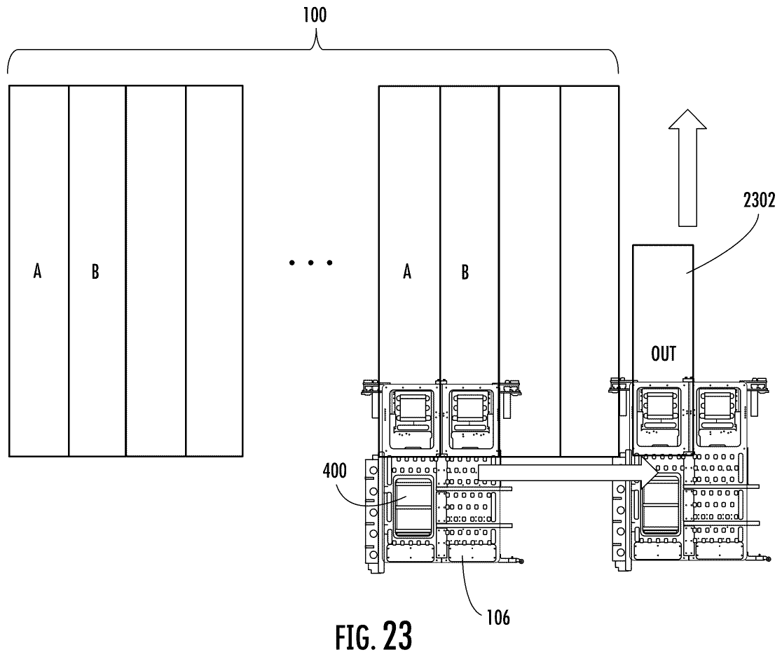

As previously mentioned, a tote 400 may be output from storage system 100 by virtue of a series of downward-sloping ramps. FIG. 23 shows such an arrangement and the delivery of a tote 400 from row “A” in storage structure 100 to output ramp 2302. In this scenario, tote 400 is loaded onto carrier 106 as previously described using continuous drive mechanism 602. The tote then moves laterally to downward-sloping output row 2302, where the tote is accelerated toward output row 2302 by acceleration drive mechanism 604 and moved into output row 2302 by continuous drive mechanism 602. Once tote 400 has been completely offloaded from carrier 106, it is gravity fed downward row 2302 where it may be retained at the end of row 2302 by a retention mechanism 1604. Once at the end of output row 2302, the tote 400 may be offloaded to, for example, a horizontal or vertical conveyor, as previously described. In various embodiments, either the left row or the right row on carrier 106 may align with output row 2302. In the scenario shown in FIG. 23, tote 400 is loaded from row “A” of storage structure 100 into the left row of carrier 106 and the left row of carrier 106 is aligned with output row 2302. Is also possible that tote 400 could be transferred to the right row of carrier 106, whereupon the right row of carrier 106 would align with output row 2302. This method of outputting totes from storage structure 100 has the advantage of not requiring additional mechanisms (for example, conveyors) to transfer totes laterally.

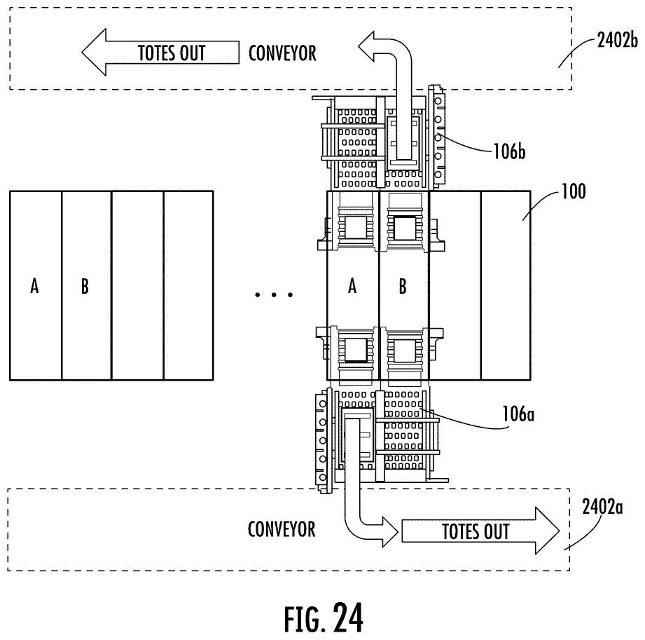

FIG. 24 shows yet another scenario for outputting a tote 400 from storage structure 100. In this case, storage structure 100 is configured with conveyors 2402a, 2402b located on opposite sides thereof. In this case, carrier 106a removes the tote from row “A” of storage structure 100 and delivers it via the scenario described with respect to FIG. 21 to conveyor 2402a. Likewise, carrier 106b may remove a tote from row “B” of storage structure 100 and deliver it to conveyor 2402b. In various embodiments of the invention, storage structure 100 may be provided with conveyors on one or both ends of the rows. In addition, in various embodiments, conveyors 2402a and 2402b may move in opposite directions or may move in the same direction. In yet other embodiments, conveyors 2402a and 2402b may change directions, depending on the situation. Lastly, in various embodiments, it is not necessary that either of carriers 106a or 106b be stationary when transferring tote 400 to the conveyor. The delivery of tote 400 to may occur as carrier 106a, 106b is in motion, for example, in the process of moving to another row within the layer of storage structure 100.

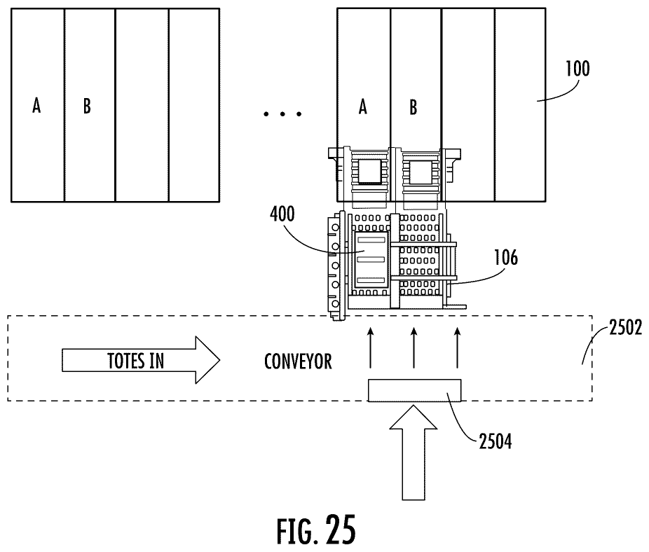

Conveyors located on one or both sides of storage structure 100 may also be used to intake totes into storage structure 100 as shown in FIG. 25. Totes 400 may be fed onto conveyor 2502 by any known means. At any point along conveyor, tote 400 may be pushed onto a carrier 106 by push mechanism 2504. In one embodiment wherein carrier 106 is stationary carrier 106, it would be desirable that the speed of side shift mechanism 606 on tote 106 match the speed of conveyor 2502. In another embodiment, carrier 106 may accept the transfer of tote 400 as it is moving, in which case is desirable to match the speed of conveyor 106 with the speed of conveyor 2502. Once tote 400 has been fully loaded onto carrier 106, carrier 106 may stop at any row within storage structure 100 to insert tote 400 into the row.

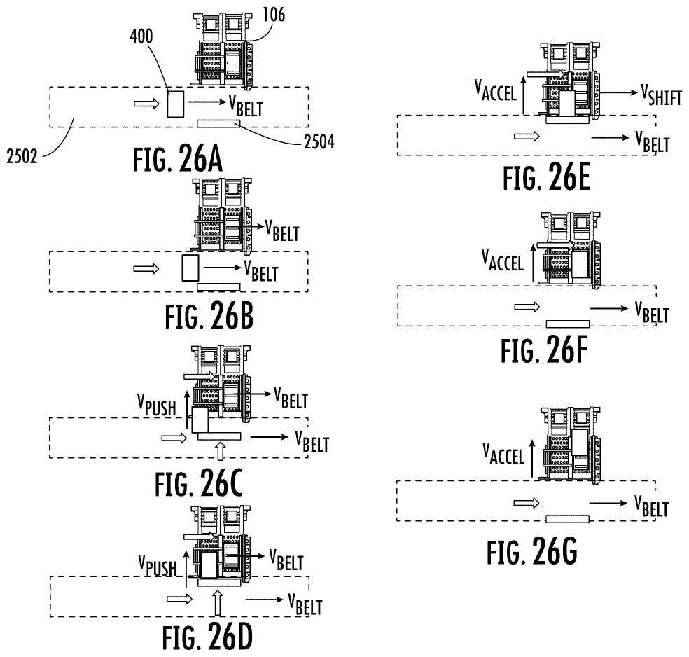

FIG. 26 shows a series of steps for transferring tote 400 from conveyor 2502 to carrier 106. Table 1 below shows the state of each of the components during the process. In step (a), tote 400 is proceeding along conveyor 2502, which is preferably moving at a constant velocity. In step (b), tote 400 is approaching carrier 106 to which it is to be loaded. In preparation for accepting tote 400, the speed of side shift mechanism 606 on carrier 106 is adjusted to match the speed of conveyor 2502. In step (c), pusher 2504 begins to push tote 400 toward carrier 106. Preferably, pusher 2504 begins to push tote 400 such as to align tote 400 between growsers 1302 of side shift mechanism 606. In addition, the speed of acceleration drive mechanisms 604 in both the left and right rows of carrier 106 should match the velocity of pusher 2504. In step (d), tote 400 has been completely loaded onto carrier 106. At this point, pusher 2504 comes to a stop. In step (e), side shift mechanism 606 is moving tote 400 from the left row to the right row of carrier 106 and at the same time the acceleration drive mechanisms 604 in both the left row and the right rows of carrier 106 are moving toward storage structure 100. In step (f), pusher 2504 retracts to the opposite side of conveyor 2502 and tote 400 is fully loaded onto carrier 106. Step (g) shows tote 400 being loaded into storage structure 100 by carrier 106, however, as would be realized, carrier 106 may delay moving tote 400 into storage structure 100 until tote is aligned with the desired destination row.

TABLE 1

| Step | Belt | Pusher | Side Shift | Accelerator |
|---|---|---|---|---|
| A | Constant | Stopped | Stopped | Stopped |
| | Velocity | | | |
| | (Vbelt) | | | |
| B | Constant | Stopped | Match Belt | Stopped |
| | Velocity | | Velocity | |
| | (Vbelt) | | | |
| C | Constant | Constant | Constant | Match |
| | Velocity | Velocity | Velocity | Pusher |
| | (Vbelt) | (Vpush) | (Vbelt) | Velocity |
| D | Constant | Constant | Constant | Constant |
| | Velocity | Velocity | Velocity | Velocity |
| | (Vbelt) | (Vpush) | (Vbelt) | (Vpush) |
| E | Constant | Stopped | Constant | Constant |
| | Velocity | | Velocity | Velocity |
| | (Vbelt) | | (Vbelt) | (Vpush) |
| F | Constant | Retract to | Stopped | Constant |
| | Velocity | Original | (Aligned | Velocity |
| | (Vbelt) | Position | to Row) | (Vpush) |
| G | Constant | Stopped | Stopped | Constant |
| | Velocity | | (Aligned | Velocity |
| | (Vbelt) | | to Row) | (Vpush) |

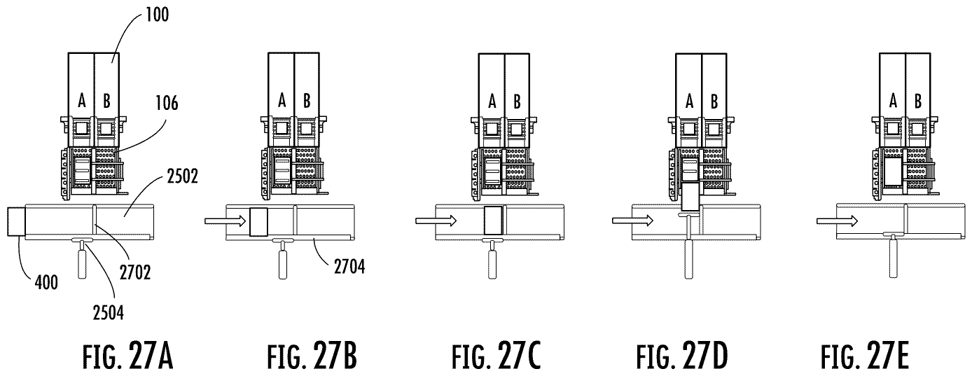

FIG. 27 shows an alternate embodiment of a method of aligning a tote with a row in carrier 106 such as to be able to push the tote from conveyor 2502 onto carrier 106. In this embodiment, tote 400 is stopped from moving with conveyor 2502 via fixed stopper plate 2702. In various embodiments, a low friction interface between tote 400 and conveyor 2502 may be provided to allow conveyor 2502 to continue its motion even though tote 400 has been stop by stopper plate 2702. Stopper plate 2702 holds tote 400 in alignment with a row (either left or right row) of carrier 106 until pusher 2504 can push tote 400 into the row on the carrier. In other embodiments, conveyor 2502 may stop once tote 400 contacts stopper plate 2702. In step (a) of FIG. 27, tote 400 is loaded onto conveyor 2502 from any source. At step (b), conveyor 2502 may be provided with rear backer plate 2704 to maintain alignment of tote 400 as it traverses conveyor 2502. At step (c), stopping plate 2702 stops the forward progress of tote 400 and aligns it for loading onto a row of carrier 106. At step (d), pusher 2504 pushes tote 400 on to carrier 106 and, at step (e) acceleration drive mechanism 604 accelerates tote 400 toward storage structure 100. There are at least three possible embodiments for stopper plate 2702. In a first embodiment, each row of storage structure 100 is provided with a stopper plate 2704 that may be moved into and out of position such as to stop a tote 400 or to allow the tote 400 to pass. In the second embodiment, conveyor 2502 may be provided with one or more stopper plates 2702 that move with the conveyor 2502. In the third embodiment, stopper plate 2702 may be attached to carrier 106 and may move with carrier 106.

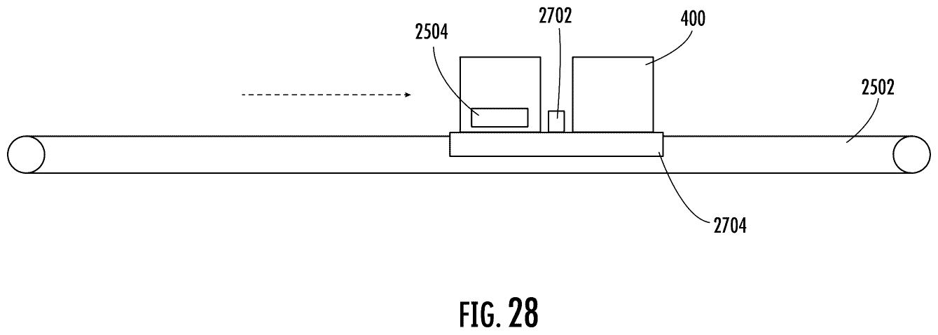

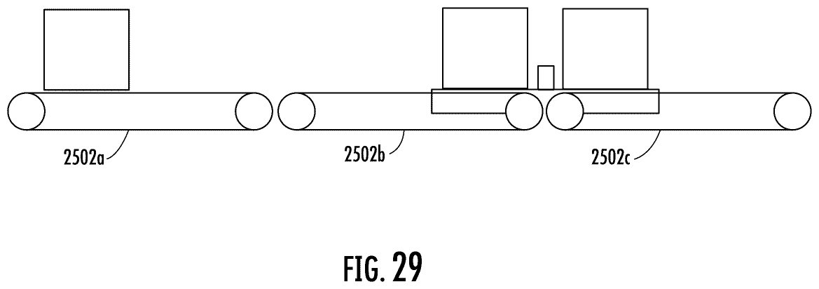

FIG. 28 shows one embodiment of the configuration described with respect to FIG. 27 in which the components are attached to carrier 106 and move with the carrier as the carrier moves back and forth with respect to storage structure 100 and conveyor 2502. FIG. 28 shows an embodiment wherein backer plate 2704, stopper plate 2702 and pusher 2504 are connected to carrier 106 via a portion of carrier 106 which extends above conveyor 2502. However, in alternate embodiments, backer plate 2704, stopper plate 2702 and/or pusher 2504 may connected to the carrier 106 via a portion of carrier 106 which extends underneath of conveyor 2502. Also, it should be noted that pusher 2504 is shown on the left row of carrier 106, however, as would be realized by one of skill in the art, multiple pushers may be provided on carrier 106, for example, one for each row of carrier 106, or for selected rows of carrier 106, in the event that carrier 106 is multiple rows in width. As such, with respect to carrier 106 shown in FIG. 28, pusher 2504 could alternatively be located on the right row of carrier 106. FIG. 29 shows yet another embodiment wherein conveyor belt 2502 may be segmented, for example, in the segments 2502a, 2502b and 2502c. In this case, the embodiment described with respect FIG. 28 wherein backer plate 2704, stopper plate 2702 and pusher 2504 are connected to carrier 106 is able to accommodate the segmented conveyor.

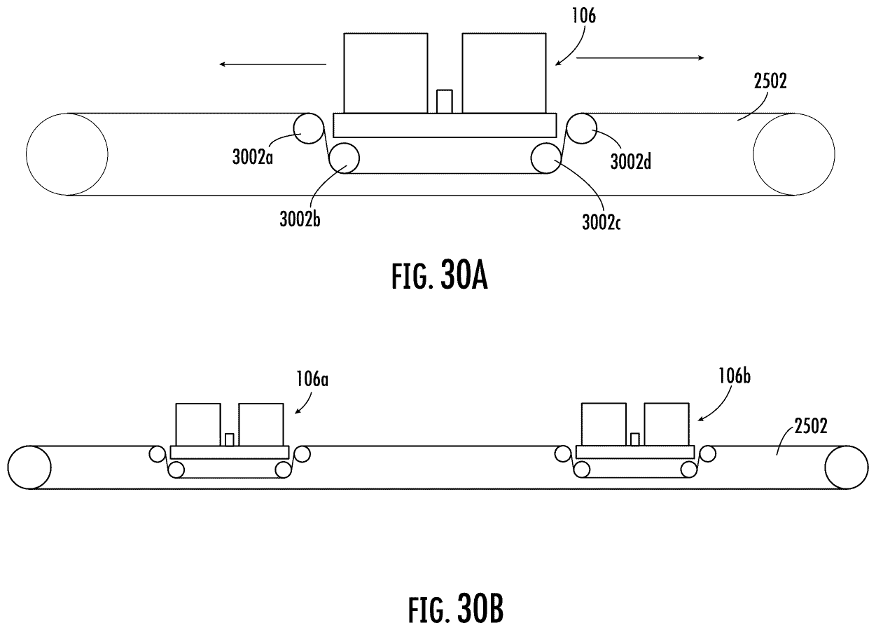

FIG. 30 (a) shows yet another embodiment wherein carrier 106 is provided with a series of pulleys 3002 (a-d) which engage the belt portion of conveyor 2502 and allow the carrier to move with respect to conveyor 2502 even if conveyor 2502 is in motion in either direction. Preferably the belt portion of conveyor 2502 is aligned with the side shift mechanism 606 of carrier 106, such that the side shift mechanism 606 may be used to move totes 400 from carrier 106 onto conveyor 2502 and from conveyor 2502 onto carrier 106. Therefore, preferably the side shift mechanism 606 of carrier 106 moves at a velocity that matches the velocity of conveyor 2502. FIG. 30 (b) shows yet another embodiment wherein multiple carriers 106 may be disposed on the conveyor 2502 to allow for complete freedom of movement of one or more carriers 106 anywhere along the length of conveyor 2502. This config also allows for the ability to shift totes from a first carrier 106a to a second carrier 106b by unloading the tote from carrier 106a, allowing the tote to move to carrier 106b along the conveyor 2502 and then loading the tote onto carrier 106b. As would be realized by one of skill in the art, any number of carriers 106 may be disposed along conveyor 2502 in the configuration shown in FIG. 30 (b).

### Tote Retention Mechanism

Anytime a tote is placed on a downward sloping ramp, whether it be an intake ramp or an output ramp, the tote is gravity fed to the bottom of the ramp, where it must be retained until a carrier 106 is available to remove it from the end of the row. As such, a tote retention mechanism 1604 must be provided at the bottom of each sloped ramp. In some embodiments wherein storage structure 100 is not level, retention mechanisms can be added to each row to maintain totes within the storage structure.

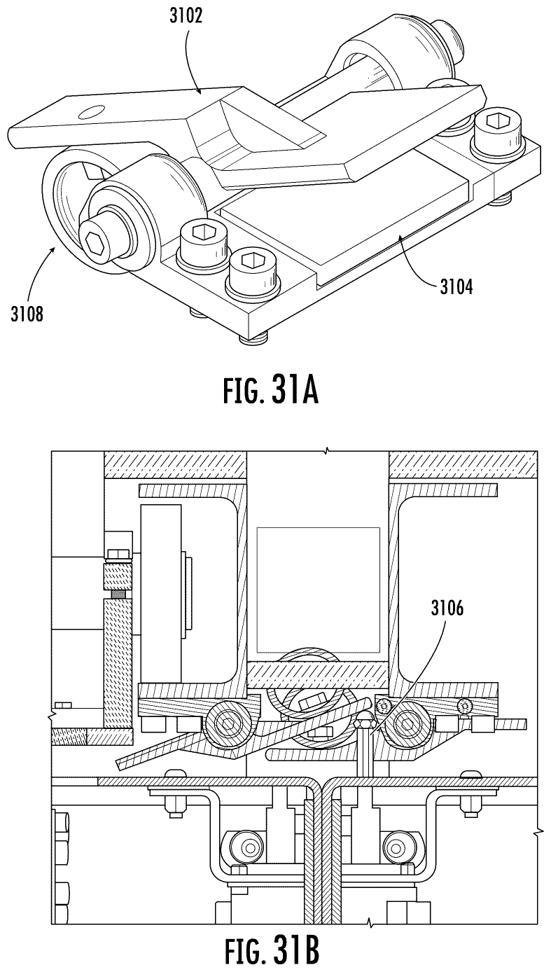

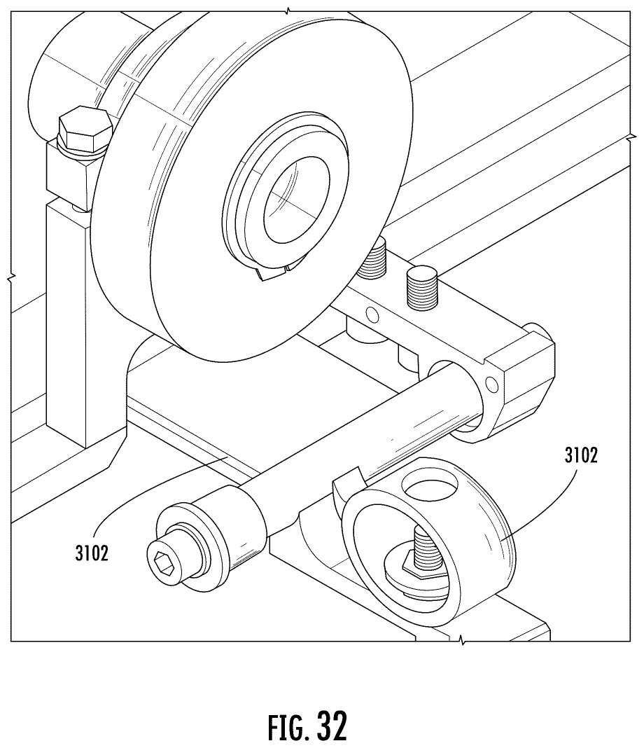

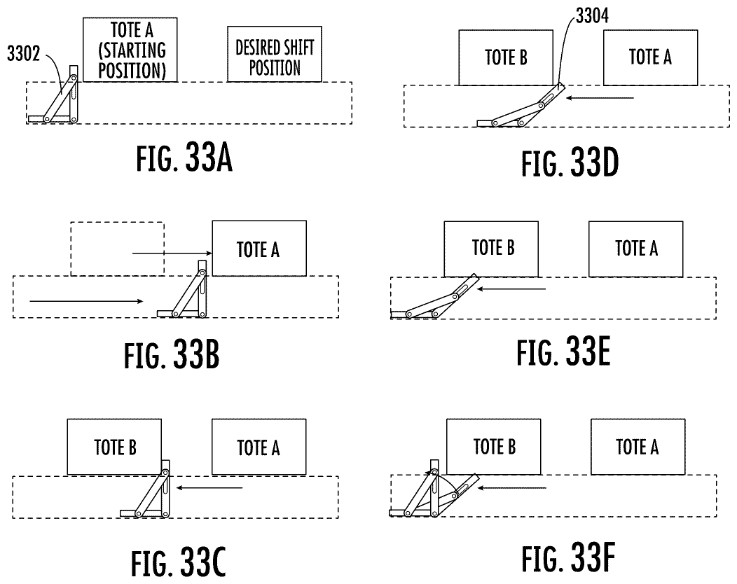

One possible embodiment of the tote retention mechanism 1604 is shown in FIG. 31(a). The retention mechanism 1604 comprises a rotating gate 3102 which pivots to either block the tote from proceeding in a first state or to allow the tote to proceed in a second state. In the first state, wherein the tote is prevented from proceeding, the rotating gate 3102 is held in place by locking magnet 3104. When retention mechanism 1604 switches to the second state to allow the tote to pass, the rotating gate 3102 is nudged from contact with locking magnet 3104 by push mechanism 3106, shown in FIG. 31(b). When the push mechanism 3106 retracts, rotating gate 3102 is again rotated into contact with locking magnet 3104 by spring 3108. Retention mechanism 1604, as shown in FIGS. 31(a-b) is shown in the second state, wherein the tote is allowed to pass. FIG. 31(b) shows mechanism 1604 in situ. As may be realized, a retention mechanism 1604 may be located at both sides of the track, such that both ends of the tote are retained equally to prevent skewing of the tote. Retention mechanism 1604 is shown in its first state in FIG. 32 where the rotating gate 3102 is engaged with the bottom of the tote to prevent movement of the tote off of the sloped ramp.

### Shifting Mechanism

It may, at times, be necessary to shift tote from a first position to a second position, for example, when shifting a tote from the pick station lift mechanism 1606 to the input ramp. FIG. 33 shows a spring-loaded push mechanism 3302 for accomplishing the shifting of a tote. FIG. 33(a), shows tote “A” in a first position, the desired position and push mechanism 3302. In FIG. 33(b), push mechanism 3302 has pushed tote “A” to the desired position. FIG. 33(c) shows that tote “B” has replaced tote “A” and it is now desired to push tote “B” into the position now occupied by tote “A”. Push mechanism 3302 moves backward and, as it contacts tote “B”, as shown in FIGS. 33(d-e), the spring-loaded head 3304 of push mechanism 3302 bends forward to allow clearance around tote “B”. As shown in FIG. 33(f), as push mechanism 3302 reaches the end of tote “B”, the spring-loaded head 2304 springs back up and pushing mechanism 3302 is now ready to push tote “B” into the desired position. As would be realized by one of skill in the art, many other variations of push mechanism 3302 may be possible and are contemplated to be within the scope of the invention.

### Carrier Control

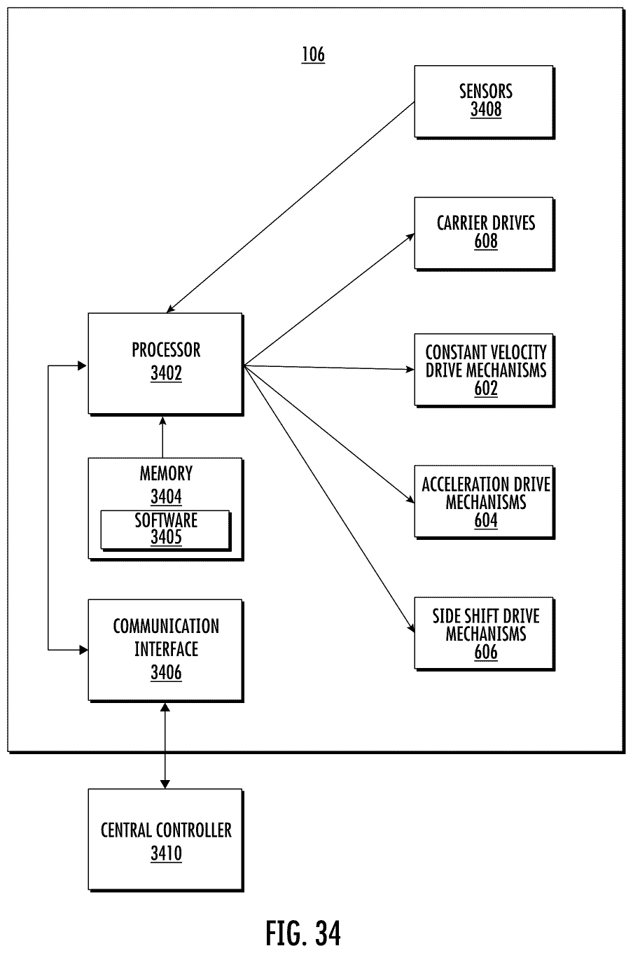

Carriers 106 are intended to act autonomously based on receiving high-level commands from a central controller 3410. FIG. 34 is a logical block diagram of carrier 106. Preferably, each carrier 106 is configured with processor 3402 in communication with memory 3404 which contains software, firmware or other forms of programming 3405 enabling carrier 106 to carry out the received high-level commands. Carrier 106 is also configured with a communication interface 3406 in communication with processor 3402. The communication interface allows communication between carrier 106 and central controller 3410 to enable the reception of high-level commands from a central controller and the reporting of the status of execution of the high-level command by carrier 106. Preferably, the communication interface 3406 is a wireless interface (e.g., Wi-Fi) in communication with central controller 3410, however, any form of wired or wireless communication interface 3406 may be used.

Central controller 3410 controls the overall operation of storage system 100 and contains a database containing the locations of all totes in storage system 100 as well as other information regarding the totes (e.g., contents of the totes, barcode identifiers of the totes, etc.) as well as the status of all carriers 106 and each row in storage system 100.

Processor 3402 executes software 3405 loaded from memory 3404, which enables the processor 3402 to control continuous drive mechanisms 602, acceleration drive mechanisms 604, and side shift drive mechanisms 606 to affect the high-level command. In addition, processor 3402 may receive input from one or more sensors 3408, which provide information regarding the position of totes on carrier 106 such as to provide cues for the control of drive mechanisms 602, 604, 606.

As previously discussed, carrier 106 may have any number of the various forms of drive mechanisms 602, 604, 606, depending upon its configuration (e.g., the carrier 106 may be configured to be any number of rows wide). Software 3405 is aware of the configuration of carrier 106 and causes processor 3402 to control any number of drive mechanisms 602, 604, 606.

Under control of software 3405, carrier 106 is also required to be able to autonomously navigate itself to a particular row within the layer of storage system 100 (if necessary) in which is deployed to carry out the high-level command. Thus, in some embodiments, processor 3402 controls carrier drive(s) 608 to move carrier 106 such as to be aligned with one or more rows in storage structure 100. One or more of sensors 3408 may provide information to processor 3402 to allow processor 3402 to determine when carrier 106 is aligned with the required rows.

When the tote needs to be retrieved from or stored to storage system 100, central control 3410 decides which of carriers 106 to issue high-level commands to. For retrieval of a tote, in some instances, the tote-of-interest may be able to be retrieved by a single, primary carrier 106. In other instances, for example, when several totes that are not of interest need to be removed from a row and stored in a destination row before the tote-of-interest is positioned on the primary carrier, and when pushing totes into the destination row will cause totes to be pushed from the opposite end of the destination row, a secondary carrier 106 may be required to retrieve the totes pushed out of the destination row and to cycle them into the source row. Thus, the central control 3410 may issue high-level commands to both a primary carrier 106 and a secondary carrier 106, which work in tandem to achieve the high-level command. Typically, storage of a tote will require only a single, primary carrier 106.

Examples of high-level commands (translated to English) received from the central controller 3410 would be “retrieve the 5^{th} tote from row 12 of layer 10 and deliver to output” or “pick up a tote from intake and store it in layer 8, row 15”. High-level commands may also include a specification of the direction of cycling for retrieval of the tote. For example, when retrieving a tote from a source row, the tote can be shifted to either the right or the left on the primary carrier 106, resulting in either a clockwise or counterclockwise cycling of the totes until the tote of interest is located on the primary carrier 106 (because, e.g., certain high-level optimizations may require that the totes be cycled in a clockwise or counterclockwise direction). High-level commands may also include other information, for example, the number of open spots in the destination row, such that a primary carrier 106 and a secondary carrier 106 know when they are required to be at their respective ends of the row.

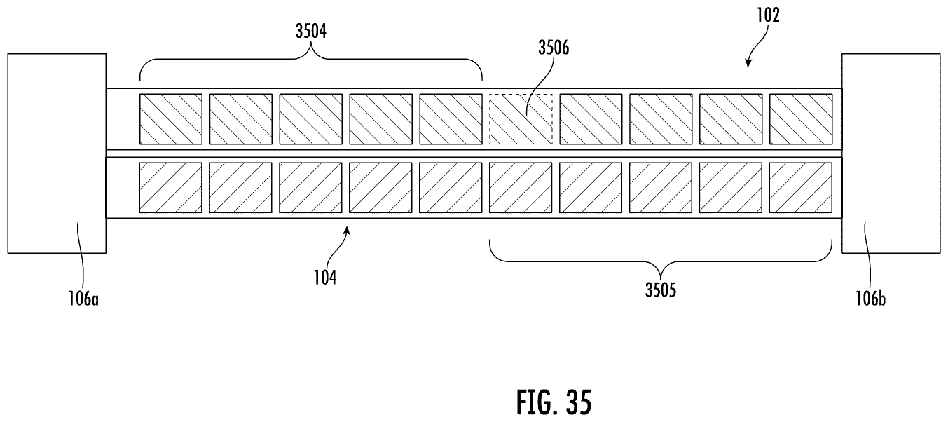

FIG. 35 is a simple schematic diagram which will be used to explain the process of retrieving a tote-of-interest 3506. Tote-of-interest 3506 is located in a source row 102-Of-interest 3506 on the primary carrier 106A, it is necessary to move totes 3504 from source row 1022 destination row 104 using primary carrier 106a in tandem with secondary carrier 106b.

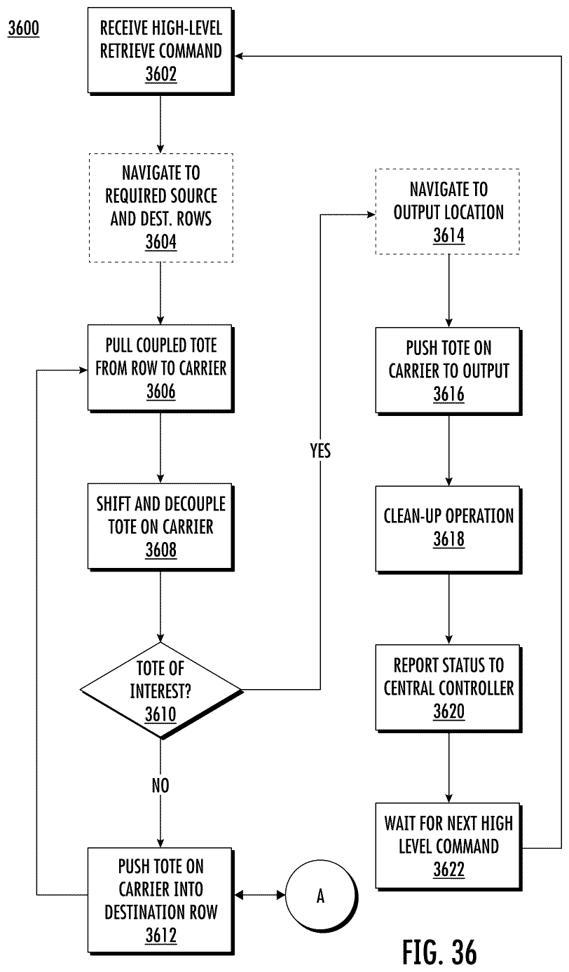

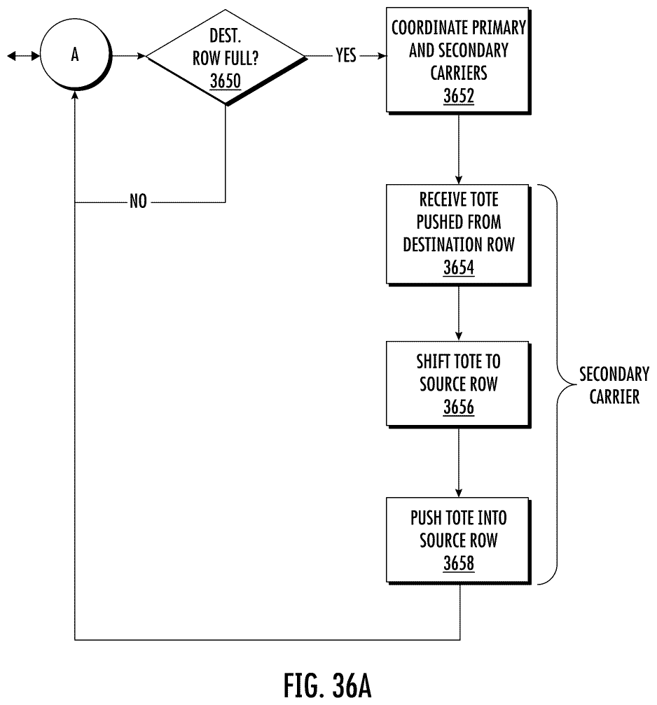

FIG. 36 is a high-level flowchart showing process 3600 for retrieval of a tote-of-interest 3506. Retrieval of tote-of-interest 3506 from any given spot within storage system 100 may require either a primary carrier 106a, or a combination of a primary carrier 106a and a secondary carrier 106b. If tote-of-interest 3506 resides in the middle of a row (i.e., source row 102), as shown in FIG. 35, several totes 3504 will have to be removed from source row 102 and stored in another row (i.e., destination row 104). If destination row 104 has enough empty space to accommodate the totes 3504 that need to be removed from source row 102, a single primary carrier 106a may be used to retrieve tote-of-interest 3502. However, if there is not enough room in destination row 104 to accommodate the totes 3504 that need to be removed from source row 102 (as shown in FIG. 35), a secondary carrier 106b is positioned on the opposite end of destination row 104 and source row 102. Primary carrier 106a moves totes 3504 from source row 102 and shifts totes 3504 to destination row 104, where they are pushed into destination row 104, causing totes 3505 to be pushed out of the opposite end of destination row 104. Secondary carrier 106b retrieves totes 3505 as they are pushed out of the opposite end of destination row 104 and shifts them to source row 102, where they are pushed into source row 102. Central controller 3410 is aware of how many totes are in each row of storage system 100 and can determine if only a primary carrier 106a is required to retrieve a particular tote-of-interest 3506, or if both the primary carrier 106a and the secondary carrier 106b are required.

To begin the retrieval of a tote-of-interest, central controller 3410 issues a high-level command to retrieve tote-of-interest 3506. The high-level command may be sent to either primary carrier 106a or to primary carrier 106a and secondary carrier 106b, as required as discussed above. The flowchart in FIG. 36 shows the actions of primary carrier 106a. At 3602, the high-level command to retrieve tote-of-interest 3506 is received at primary carrier 106a. The high-level command may include, for example, among other information, an identification of the tote-of-interest 3506 to be retrieved, the location of tote-of-interest 3506 within storage system 100, how many totes 3504 must be cycled out of source row 102 until the tote-of-interest 3506 is moved to primary carrier 106a and whether a clockwise or counterclockwise cycling action is desired.

At optional step 3604, primary carrier 106a navigates to and aligns itself with the required source row 102 and destination row 104. To navigate to the required source row 102 and destination row 104, processor 3402, executing software 3405, issues one or more commands to carrier drives 608, which causes primary carrier 106a to move in either the left or right direction until it is aligned with the required source row 102 and destination row 104. Additionally, to assist in the alignment of primary carrier 106a with the required source row 102 and destination row 104, processor 3402 may receive input from one or more of sensors 3408, which may be disposed on various locations either on storage structure 100 or on primary carrier 106a. Because different configurations of carriers 106 exist, it is possible that primary carrier 106a may not need to navigate to the desired source row 102 and destination row 104 and, as such, step 3504 is optional. For example, in some embodiments, primary carrier 106a may be as wide as the entire layer of storage structure 100 on which it resides, in which case no movement of primary carrier 106a is required. In another example, primary carrier 106a may be already aligned with the source row 102 and destination row 104.

Once the primary carrier 106a is aligned with the required source row 102 and destination row 104, the process to retrieve the tote-of-interest begins. At step 3606, a tote 3504 is pulled from source row 102 and loaded onto primary carrier 106a. The movement of tote 3504 onto primary carrier 106a causes all of the coupled totes in source row 102 to move in the direction of primary carrier 106a. The exact sequence issued by processor 3402 to control drives 602, 604, 606 on primary carrier 106a will be discussed later. At step 3608, the tote is shifted on primary carrier 106a in either the left or right directions, depending on whether a clockwise or counterclockwise cycling motion is desired, until it is aligned with destination row 104.

At 3610, it is determined if the tote currently on primary carrier 106a is tote-of-interest 3506 and, if so, control transfers to step 3614 wherein processor 3402 issues commands to control carrier drive 608 to navigate the primary carrier 106a to an output location. Once again, step 3614 is optional to accommodate embodiments wherein the carrier is as wide as the layer on which is deployed, in which case, the tote-of-interest 3506 would be moved to the output location by virtue of shifting on primary carrier 105a across multiple rows until the tote-of-interest is aligned with the output location. At step 3616, the tote-of-interest 3506 reaches the output location, which has been previously described, from which it will ultimately be moved to a pick station.

At step 3618, an optional clean-up may be performed. This step may be required to leave the storage structure 100 in a state in which all totes are safely secured in the rows and ready for the next tote operation. This final phase could include, for example, pulling any totes protruding from the storage structure (that are not being picked) back into the storage rows, pushing totes into the storage structure on both ends to ensure latching of all totes in the chain, and/or positioning totes within the storage row accurately enough in order to be aligned with a retention mechanism.

Primary carrier 106a thereafter reports the status of the retrieval of the tote-of-interest 3506 to the central controller 3410 at step 3620 and at step 3622, waits for the next high-level command to be received, at which time, the process returns to step 3602 and starts over.

If it is determined that both a primary carrier 106a and a secondary carrier 106b are required to retrieve the tote-of-interest 3506, (i.e., when operation with a single carrier 106 would result in totes being pushed out of the opposite end of destination row 104, as shown in FIG. 35), central controller 3410 will have sent a high-level command to secondary carrier 106b. At step 3612, as a tote is being pushed into destination row 104 by primary carrier 106a, control simultaneously transfers to point “A” in FIG. 36A, which describes the actions of secondary carrier 106b. At step 3650, it is determined if destination row 104 is full, such that a tote 3504 being pushed into destination row 104 by primary carrier 106a will cause a tote 3505 to be pushed out of the opposite end of destination row 104 where it must be retrieved by secondary carrier 106b. Thus, secondary carrier 106b may sit idle at the opposite end of destination row 104 until destination row 104 is full and totes 3505 start being pushed out of destination row 104. In some instances, while primary carrier 106a is filling up destination row 104 with totes 3504 retrieved from source row 102, secondary carrier 106b may be otherwise engaged and may only be required to navigate to the required rows when destination row 104 has been completely filled. Thus, secondary carrier 106b, may arrive at the required position after primary carrier 106a has begun removing totes 3504 from source row 102 and pushing them into destination row 104. Once destination row is full 104, control proceeds to step 3652 where primary carrier 106a and secondary carrier 106b communicate and coordinate with each other. The communication between primary carrier 106a and secondary carrier 106b may be via a wireless connection (e.g., Wi-Fi) or via any other form of communication. The coordination between the primary carrier 106a and secondary carrier 106b may be, for example, indicating when a tote is expected to be pushed out of the opposite end of destination row 104, coordinating the speed at which totes are moving as they are cycled between the source and destination rows, etc.

At step 3654, secondary carrier 106b, receives a tote 3505 which has been pushed from destination row 104 by the insertion of a tote 3504 in the destination row 104 by primary carrier 106a. At step 3656, secondary carrier 106b shifts the tote 3505 to source row 102 and, at step 3658, secondary carrier 106b pushes the tote 3505 into source row 102. Preferably, secondary carrier 106b will execute the same software 3405 as primary carrier 106a, and will understand that it may, at some times, act as a primary carrier and, at other times, act as a secondary carrier.

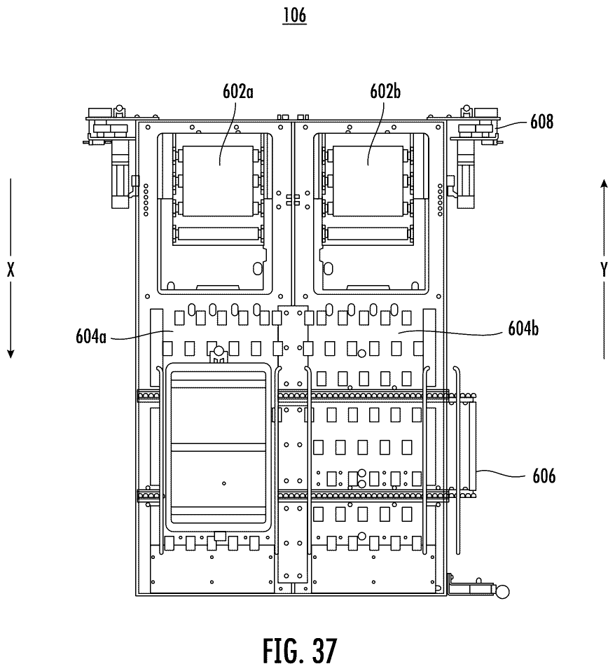

The control of individual drives on primary carrier 106a and secondary carrier 106b will now be explained. Carriers 106 may be any number of rows in width, with one row aligned with source row 102 and another row aligned with destination row 104. Note that it is not required that source row 102 and destination row 104 be adjacent each other. If carrier 106 is multiple rows in width, the source row 102 and destination row 104 may be separated by other rows. FIG. 37 is a schematic of carrier 106 showing a simplest case in which carrier 106 is two rows in width. Each carrier 106 will have a source continuous drive mechanism 602a and a source acceleration drive mechanism 604a aligned with source row 102, a destination continuous drive mechanism 602b and a destination acceleration drive mechanism 604b aligned with destination row 104, and a shift drive mechanism 606 which shifts totes from a position on the carrier aligned with the source row 102 to a position on the carrier aligned with destination row 104. As previously discussed, the shift drive mechanism 606 may shift the totes any number of rows necessary to cover the distance between source row 102 and destination row 104. Further, each carrier 106 may have many more continuous drive mechanisms 602 and acceleration drive mechanisms 604, depending on the width of carrier 106 (i.e., the number of rows wide).

In general, each operation of shifting a tote from source row 102 to destination row 104 may be broken into four phases. In a first phase, the tote is pulled from source row 102 at a constant velocity. In a second phase, the tote is shifted from a position on carrier 106 aligned with source 102 to a position on carrier 106 aligned with destination row 104, while still moving at the constant velocity. In a third phase, the tote experiences a high-speed push (i.e., at a speed greater than the constant velocity) toward destination row 104. Finally, in a fourth phase, the tote is moved at the constant velocity into destination row 104.

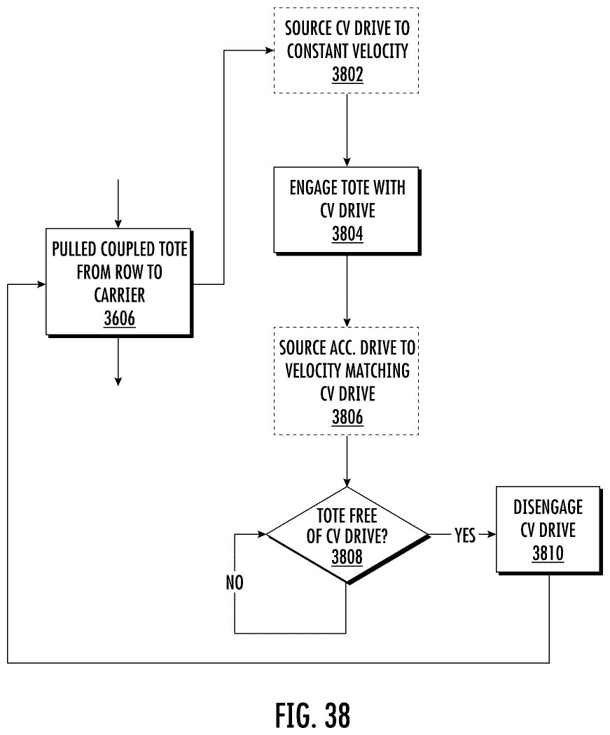

FIG. 38 shows the details of step 3606 from FIG. 36, which implements the first phase described above. At step 3802, processor 3402 instructs source continuous drive mechanism 602a to move in direction “X” at a constant velocity. The constant velocity may be a pre-programed constant velocity or may be dynamically adaptable under the control of the central controller 3410. It should be noted that step 3802 is shown as being an optional step because the source continuous drive mechanism 602a may already be moving at the constant velocity in direction “X” as a result of moving a previous tote out of source row 102. At step 3804, the source continuous drive mechanism 602a engages the tote at the end of source row 102, causing it to move at the constant velocity in direction “X”, which also causes all totes coupled to the tote at the end of source row 102 to move in direction “X”. At step 3806, source acceleration drive 604a is controlled by processor 3402 to move in direction “X” at the constant velocity. Step 3806 is also shown as being optional because the source acceleration drive mechanism 604a may already be moving at the constant velocity and direction “X” as a result of moving a previous tote. At step 3808, it is determined if the tote is free of the source continuous drive mechanism 602a. This may be determined by an input to processor 3402 by one or more of sensors 3408. Once the tote has moved to a position which is substantially on source acceleration drive mechanism 604a, the source continuous drive mechanism 602a is disengaged from the tote at step 3810. Note that, at this point, the end tote, which is now completely on carrier 106, is still coupled with other totes in source row 102.

In preferred embodiments of the invention described herein the continuous drive mechanism 602 frictionally engages the tote. However, as would be realized, other designs of the continuous drive mechanism 602 or other means of engaging or disengaging the tote are contemplated to be within the scope of the invention.

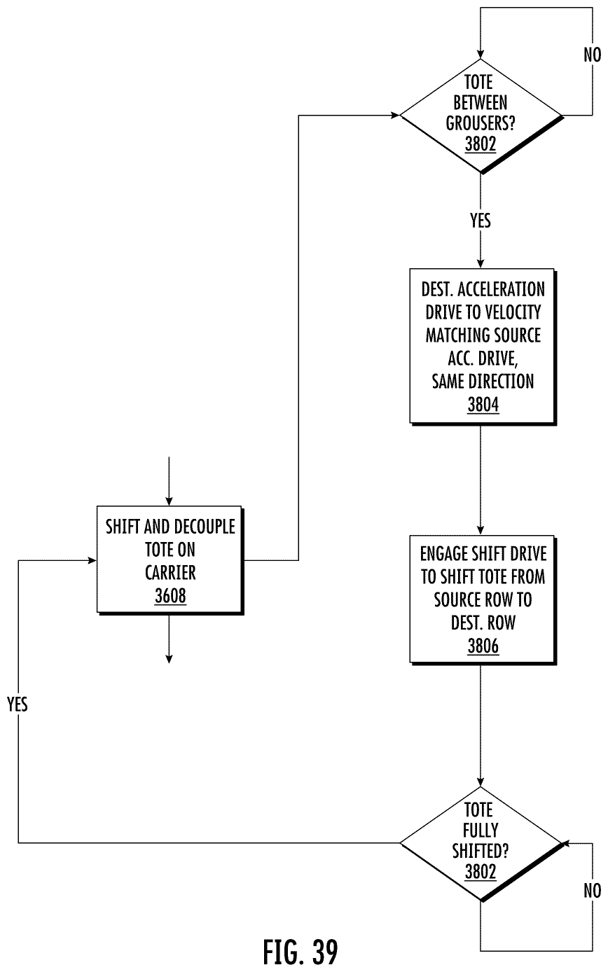

FIG. 39 shows the details of step 3608 from FIG. 36, which implements the second phase in the movement of a tote from source row 102 to destination row 104, as described above. In this phase, the tote is shifted from a position on the carrier aligned with the source row 1022 a position on carrier aligned with the destination row 104. However, the tote cannot be shifted until it is completely clear of source continuous drive mechanism 602a and is completely between the grousers of the shift drive mechanism 606. At step 3802, the process waits until the tote is positioned between the grousers. Processor 3402 senses when the tote is completely between the grousers based on input from one or more of sensors 3408. To shift the tote from the position on the carrier aligned with source MXXII the position on the carrier aligned with destination row 104, the destination acceleration drive 604b must be brought to a velocity matching the velocity of the source acceleration drive 604a. And moving in the same direction, that is, away from the storage structure, in direction “X” as shown in FIG. 37. Processor 3402 send signals to the destination acceleration drive 604b instructing it to match the speed and direction of the source acceleration drive 604a. Once both the source acceleration drive 604a and the destination acceleration drive 604b are moving at the same speed and in the same direction, the shifting of the tote can begin. Processor 3402 sends signals to the shift drive mechanism 606 instructing the shift drive mechanism 606 to shift the tote from the position aligned with source row 102 to the position aligned with the destination row 104 on primary carrier 106a. Once the tote is fully shifted at step 3802, step 3608 of FIG. 36 is completed. Processor 3402 receives input from one or more of sensors 3408 to determine when the tote has been fully shifted to the position on primary carrier 106a aligned with the destination row 104.

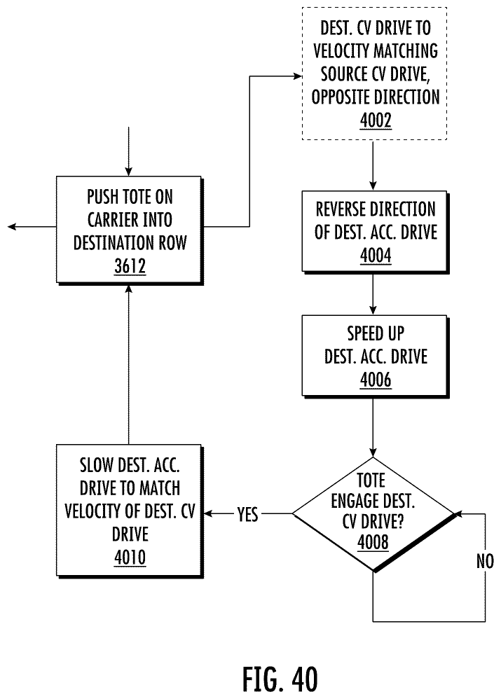

FIG. 40 shows the details of step 3612 from FIG. 36, which implements the third and fourth phases in the movement of a tote from source row 102 to destination row 104, as described above. In the third phase, destination acceleration drive 604b accelerates the tote in direction “Y” towards destination row 104. Once the tote is at least partially engaged with destination continuous drive mechanism 602b, the fourth phase begins in which destination acceleration drive mechanism 604b slows to a speed matching destination continuous drive mechanism 604b. With reference to FIG. 40, at step 4002 it is assumed that the tote is completely at the position on primary carrier 106a aligned with the destination row 104 and when this occurs, processor 3402, at step 4002, instructs the destination continuous drive mechanism 602b to come to a velocity matching the velocity of source continuous drive mechanism 604a, but in the opposite direction, that is, in direction “Y”. Note that this is an optional step as a destination continuous drive mechanism 604b may already be at the required speed from moving a previous tote into destination row 104. Processor 3402 then, at step 4004, instructs destination acceleration drive 604b to reverse direction such as to begin movement of the tote in direction “Y”. At step 4006, processor 3402 also instructs destination acceleration drive mechanism 604b to increase its speed in direction “Y” such as to accelerate the tote towards destination row 104. At decision point 4008, it is determined if the tote has engaged the destination continuous drive mechanism 602b. Processor 3402 receives input from one or more of sensors 3408 to determine when the tote has engaged the destination continuous drive mechanism 602b. Once the tote has engaged destination continuous drive mechanism 602b, the destination acceleration drive mechanism 604b is constructed by processor 3402 to slow its velocity such as to match the velocity of the destination continuous drive mechanism 602b. The tote is then moved into destination row 104 where it may contact other totes already in destination row 104, at which point an automatic coupling would occur.

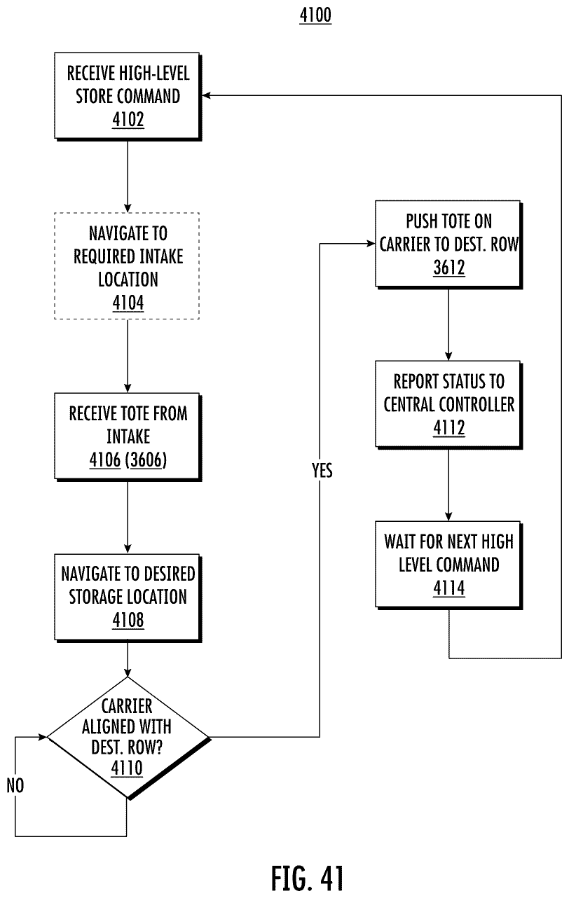

FIG. 41 is a flowchart showing process 4100 for retrieving a tote from the intake of storage structure 100 and storing it in a desire destination row. At step 4102, primary care 106 a receives a high-level storage command from central controller 3410. The command may comprise, for example, the identification of the intake (in the case where storage structure 100 may have multiple intake locations) and the desired row in which the tote is to be stored. The central controller 3410, which knows the position of all totes within storage structure 100 and the status of all rows, selects a row in which the tote is to be stored and which primary care 106a will deliver the tote to that location. Certain high-level optimizations run by central controller 3410 may dictate the optimal row and layer in which to store the tote. In primary embodiments of the invention, the tote is delivered from a pick station to a vertical conveyor, which conveys the tote to the desired layer of storage structure 100, where weights to be picked up by primary carrier 106a. Once primary care 106 a receives the high-level store command, at optional step 4104, primary care 106 a navigates to the intake location specified in the high-level command. At sometimes, the step may be optional if for example, the primary carrier 106a is already located at the intake location. At step 4106, the tote is received by the primary carrier 106a. In some embodiments, the primary carrier 106a may pull the tote from the intake using the source continuous drive mechanism 602a and the source acceleration drive mechanism 604a, in an operation identical to step 3606 from FIGS. 36 and 38. In other embodiments, the intake may be designed such as to be able to push the tote onto primary carrier 106a. At step 4108, primary carrier 106 a navigates to the desired storage location (row) and, at step 4110 primary carrier 106a aligns itself with the destination row. Processor 3402 may use inputs from one or more of sensors 3408 to determine when it is aligned with the destination row. The sensors may be located either on the primary carrier 106a or on storage structure 100. Once a carrier is aligned with destination row, the tote is pushed into destination row using a process identical to step 3612 in FIG. 36. Note that, typically, during a store operation using a mobile carrier 106, there is no need to shift the tote from a first position on the carrier to a second position on the carrier.

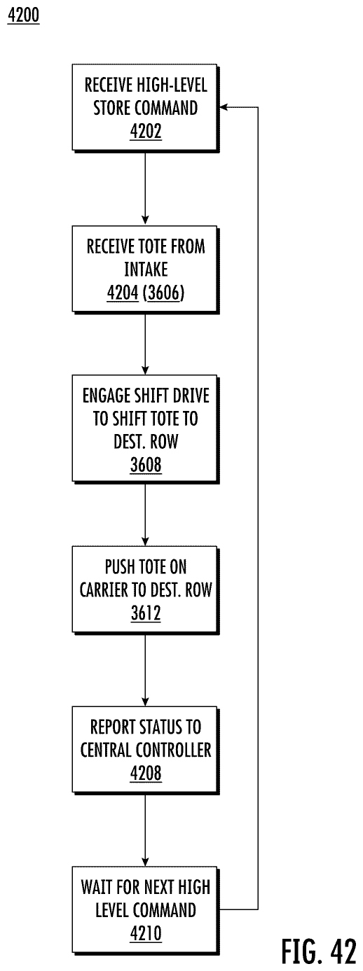

However, in a second embodiment, wherein the carrier is non-mobile and runs the entire length of a layer of storage structure 100, process 4200 shown in flowchart form in FIG. 42 may be used to store the tote. Steps 4202 and 4204 are identical to steps 4102 and 4106 in process 4100. In process 4200, however, once the tote is on primary carrier 106a, processor 3402 engages shift drive mechanism 606 to shift the tote to the desired row in a step identical to step 3608 from FIGS. 36 and 39. The tote may be shifted any number of rows to move it from the intake location to the desired destination row 104. Thereafter, the tote is pushed into the destination row using a process identical to step 3612 in FIG. 36. At step 4208, processor 3402 reports the status of the storage operation to central controller 3410 and, at step 4210, primary carrier 106A waits for the next high-level command.

In certain embodiments it may also be necessary for a carrier 106 to control other aspects of the storage environment. For example, in some embodiments, one or more rows or one or more layers of storage structure 100 may be temperature controlled and may be closed at either end by a mechanical gate. Processor 3402 on a carrier 106 is aware of the existence of the gates and may issue commands to open or close the gates. Alternatively, the gates may automatically open or close when a carrier is positioned adjacent a particular row. In other embodiments, rows may be configured with a tote retention mechanism 1604 as shown in FIGS. 31-32. In this case, processor 3402 on carrier 106B be required to issue commands to release the tote retention mechanism 1604 before receiving a tote from a particular row or storing a tote in particular row. Commands manipulating features of storage structure 100, such as gates and tote retention mechanisms may be communicated by processor 3402 wirelessly to central control 3410 to affect the desired operation.

In some embodiments, multiple carriers 106 may be deployed within the same layer of storage structure 100. In some cases, this may block access to a particular input/output location to some of the carriers. As a result, may be convenient to have the carriers be able to perform a carrier-to-carrier transfer as shown in FIG. 22. The carrier-to-carrier feature opens up the possibility of having a carrier having only a single position thereon whose sole function is to receive the totes from an input location and transfer them to other totes or receive totes from other totes and transport them to an output location. The description above with respect to FIG. 22 describes a transition area 22020 between the totes which may be implemented in a number of different ways. As far as the control of the carriers is concerned, with reference to FIG. 22, carrier 106a and carrier 106b must communicate with each other to coordinate the transfer of the tote. This coordination would include coordinating the timing of shift drive mechanism 606b on carrier 106b such that the tote arrives at carrier 106b between the grousers of shift drive 606b. This inter-carrier communication may occur wirelessly via communications interface 3406 under control of processor 3402. In this case, shift drive mechanism 606a on carrier 106a is required to push the tote with enough force such that it is able to transit transition area 2202 between carriers 106a and 106b and be engaged by shift drive mechanism 606b on carrier 106b. Therefore, processor 3402 may instruct the shift drive mechanism 606a on carrier 106a to increase its speed such as to provide enough force to propel the tote through the transition area 2202.

The invention has been described in the context of specific embodiments, which are intended only as exemplars of the invention. As would be realized, many variations of the described embodiments are possible. For example, variations in the design, shape, size, location, function and operation of various components, including both software and hardware components, would still be considered to be within the scope of the invention, which is defined by the following claims.

The invention claimed is:

1. A primary robotic carrier for a storage structure comprising:
a processor;
a communication interface; and
memory storing software that, when executed by the processor, causes the carrier to perform the functions of:
receiving a high-level command via the communication interface, the high-level command comprising an instruction to retrieve one or more totes from the storage structure or to store one or more totes in the storage structure;
controlling one or more types of drive mechanisms disposed on the carrier to autonomously execute the high-level command;
communicating with a secondary carrier disposed on an opposite end of the storage structure and aligned with the source row and the destination row; and
reporting a status of the executed high-level command via the communications interface.

2. The carrier of claim 1 wherein the high-level command is a command to retrieve a tote-of-interest from the storage structure, the software further causing the carrier to perform the functions of:
pulling a tote from an end of a source row in which the tote-of-interest resides;
shifting a tote on the carrier such as to align it with a destination row;
pushing the tote into the destination row; and
repeating the steps of claim 2 until the tote-of-interest is located on the carrier.

3. The carrier of claim 2 wherein the primary carrier communicates with the secondary carrier to:
coordinate the secondary carrier retrieving a tote pushed out of an opposite end of the destination row when the primary carrier pushes the tote on the primary carrier into the destination row;
shifting the tote pushed out of the destination row such as to align it with the source row; and
pushing the tote on the secondary carrier into the source row.

4. The carrier of claim 2 further comprising:
one or more carrier drives interfacing the carrier with the storage structure and enabling the carrier to be mobile within at least a single layer of the storage structure.

5. The carrier of claim 4 wherein the software causes the carrier to perform the further functions of:
navigating to the source row in which a tote-of-interest resides; and
aligning itself with the source row and the destination row.

6. The carrier of claim 2 wherein the software further causes the carrier to perform the further function of:
pushing the tote-of-interest into the output location.

7. The carrier of claim 6 wherein the software further causes the carrier to perform the further function of:
navigating to an output location in the storage structure.

8. A primary robotic carrier for a storage structure comprising:
a processor;
a communication interface;
a source continuous drive mechanism for pulling a tote at the end of a source row in the storage structure onto the carrier at a constant velocity;
a source acceleration drive mechanism for receiving the tote from the source continuous drive mechanism and accelerating the tote to a position on the carrier;
a shift drive mechanism for shifting the tote from a position on the carrier aligned with the source row to a position on the carrier aligned with the destination row;
a destination acceleration drive mechanism for accelerating the tote in the direction of the destination row; and
a destination continuous drive mechanism for receiving the tote from the destination acceleration drive and pushing it into the destination row at a constant velocity; and
memory storing software that, when executed by the processor, causes the carrier to perform the functions of:
receiving a high-level command via the communication interface, the high-level command comprising an instruction to retrieve one or more totes from the storage structure or to store one or more totes in the storage structure;
controlling the source continuous drive mechanism, the source acceleration drive mechanism, the shift drive mechanism, the destination acceleration drive mechanism and the destination continuous drive mechanism to autonomously execute the high-level command; and
reporting a status of the executed high-level command via the communications interface.

9. The carrier of claim 8 wherein the software causes the carrier to perform the further functions of:
instructing the source continuous drive mechanism to assume a constant velocity in a first direction away from the storage structure;
instructing the source continuous drive mechanism to engage the tote at the end of the source row;
instructing the source acceleration drive to assume a velocity matching the source continuous drive mechanism;
determining that the tote pulled from the end of the source row is disposed on the source acceleration drive;
instructing the destination acceleration drive mechanism to assume a constant velocity matching the velocity of the source acceleration drive mechanism;
instructing the shift drive mechanism to shift the tote from a position on the carrier aligned with the source row to a position on the carrier aligned with the destination row;
determining that the tote is aligned with the destination row;
instructing the destination acceleration drive mechanism to reverse direction and increase its velocity;
instructing the destination continuous drive mechanism to assume a velocity matching the velocity of the source continuous drive mechanism but in the opposite direction;
determining that a portion of the tote is positioned to engage with the destination continuous drive mechanism;
instructing the destination continuous drive mechanism to engage the tote;
instructing the acceleration drive mechanism to a velocity to move the tote from an acceleration region to a continuous drive region until the tote is engaged with the continuous drive mechanism; and
determining that the tote has been pushed into the destination row by the continuous drive mechanism.

10. The carrier of claim 9 further comprising:
one or more sensors providing input to the processor;
wherein the position of totes on the carrier are known via inputs from one or more of the one or more sensors.

11. The carrier of claim 1 wherein the high-level command is a command to store a tote-of-interest in the storage structure, the software further causing the carrier to perform the functions of:
pulling a tote-of-interest from an input location of the storage structure; and
pushing the tote-of-interest into the destination row.

12. The carrier of claim 11, the software further causing the carrier to perform the functions of:
navigating to a destination row in which the tote-of-interest is to be stored; and
aligning the carrier with the destination row.

13. The carrier of claim 12 further comprising:
a continuous drive mechanism for pulling totes from the input location onto the carrier; and
an acceleration drive mechanism for positioning a tote on the carrier.

14. The carrier of claim 13 wherein the software causes the carrier to perform the function of pulling a tote-of-interest from an input location by:
instructing the continuous drive mechanism to assume a constant velocity in a first direction away from the input location;
instructing the continuous drive mechanism to engage the tote-of-interest at the input location;
instructing the acceleration drive to assume a velocity matching the continuous drive mechanism;
determining that the tote-of-interest is disposed on the acceleration drive; and
instructing the acceleration drive to assume a zero velocity.

15. The carrier claim 14 wherein the software causes the carrier to perform the function of pushing the tote-of-interest into the destination row by:
instructing the acceleration drive mechanism to assume a velocity higher than the constant velocity in the direction of the destination row;
instructing the continuous drive mechanism to assume the constant velocity in the direction of the destination row;
determining that a portion of the tote-of-interest is positioned to engage with the continuous drive mechanism;
instructing the continuous drive mechanism to engage the tote-of-interest;
instructing the acceleration drive mechanism to a velocity to move the tote from an acceleration region to a continuous drive region until the tote is engaged with the continuous drive mechanism; and
determining that the tote-of-interest has been pushed into the destination row by the continuous drive mechanism.

16. The carrier of claim 3 wherein the carrier may act as either a primary carrier or secondary carrier.

17. The carrier of claim 1 wherein the carrier is capable of performing carrier-to-carrier transfers.

18. The carrier of claim 17 the software causing the carrier to perform the further functions of:
communicating with a second carrier to affect the transfer of the tote from the carrier to the second carrier;
instructing the shift drive mechanism on the carrier to increase its velocity such as to shift a tote across a transition area between the carrier and the second carrier;
wherein the communication with the second carrier causes the second carrier to synchronize a shift drive mechanism on the second carrier to accept the tote as it moves from the transition area to the second carrier.

19. The carrier of claim 3 wherein the carrier has a width equal to the width of the storage structure.

20. The carrier claim 19, the software further causing the carrier to perform the functions of:
determining that the tote-of-interest is on the carrier;
instructing the shift drive mechanism to shift the tote from a position on the carrier aligned with a source row to a position on the carrier aligned with an output location of the storage structure; and
instructing the acceleration drive mechanism and the continuous drive mechanism to push the tote into the output location of the storage structure.

21. The carrier of claim 19 wherein the high-level command is a command to store a tote-of-interest in the storage structure, the software further causing the carrier to perform the functions of:
pulling a tote-of-interest from an input location of the storage structure;
instructing the shift drive mechanism to shift the tote-of-interest from a location on the carrier aligned with the input location to a location on the carrier aligned with a destination row; and
instructing the acceleration drive mechanism and the continuous drive mechanism to push the tote-of-interest into the destination row.

22. A method of moving a tote-of-interest from a storage structure to a carrier comprising:
pulling a tote from an end of a source row in which the tote-of-interest resides onto a mobile carrier;
shifting a tote on the mobile carrier such as to align it with a destination row;
pushing the tote into the destination row; and
repeating the steps of claim 22 until the tote-of-interest is located on the mobile carrier.

23. The method of claim 22 further comprising:
moving the mobile carrier to an output location of the storage structure.

24. A method of storing a tote-of-interest in the storage structure comprising:
pulling a tote-of-interest from an input location of the storage structure onto a mobile carrier;
moving the mobile carrier to a destination row in which the tote-of-interest is to be stored;
aligning the mobile carrier with the destination row; and
pushing the tote-of-interest into the destination row.

25. A method of storing a tote-of-interest comprising:
pushing the tote-of-interest into a destination row.

26. The method of claim 25 further comprising:
moving the mobile carrier to align the tote-of-interest with the destination row.

27.-29. (canceled)

30. The method of claim 29 further comprising:
moving the mobile carrier to the input location; and
after the tote-of-interest is on the mobile carrier:
moving the mobile carrier to align the tote-of-interest with a destination row; and
inserting the tote-of-interest into the destination row.

31. A method of cycling totes in a storage structure:
pulling a tote from an end of a source row in which the tote-of-interest resides onto a primary mobile carrier;
shifting a tote on the primary mobile carrier such as to align it with a destination row; and
inserting the tote into the destination row;
wherein the primary carrier communicates with a secondary carrier disposed on an opposite end of the storage structure and aligned with the source row and the destination row to coordinate handling of any totes pushed out from an opposite end of the destination row.

32. The method of claim 31 further comprising:
moving the mobile carrier to align the tote with the destination row.
